(19) United States
(12) Patent Application Publication
(10) Pub. No.: US 2020/0084286 A1
(43) Pub. Date: Mar. 12, 2020

(54) METHOD, APPARATUS AND SYSTEM FOR CALL PROMPTING

(71) Applicant: Alibaba Group Holding Limited, Grand Cayman, KY (US)

(72) Inventors: Li Liu, Zhejiang (CN); Tengyu Chen, Zhejiang (CN)

(21) Appl. No.: 16/685,911

(22) Filed: Nov. 15, 2019

Related U.S. Application Data
(63) Continuation of application No. PCT/CN2018/087239, filed on May 17, 2018.

(30) Foreign Application Priority Data
May 26, 2017 (CN) 201710383895.5

(51) Int. Cl. H04L 29/08; H04L 12/58; H04L 29/06; H04M 3/42

(52) U.S. Cl. CPC H04L 67/26; H04L 51/046; H04M 2203/558; H04M 3/42042; H04M 2203/551; H04L 65/1069

(57) ABSTRACT

Method, apparatus and system for call prompting are provided. A method comprises receiving, at a server, a call request from an initiator; and sending, by the server, a push message to a target object, wherein the push message includes a call number associated with the initiator and a call number description, causing the target object to display the call number description on an incoming call interface upon receiving the call request.

### CROSS REFERENCE TO RELATED PATENT APPLICATIONS

This application claims priority to and is a continuation of PCT application No. PCT/CN2018/087239, filed on May 17, 2018, which is related to and claims priority to Chinese Patent Application No. 201710383895.5, filed on May 26, 2017, entitled “Method, Apparatus and System for Call Prompting,” which are hereby incorporated by reference in their entirety.

### TECHNICAL FIELD

The present disclosure relates to the field of communication technologies, and in particular, to call prompting methods and apparatuses, and systems.

### BACKGROUND

In related technologies, the mobile enterprise office platform is more and more widely used in the business processes of various groups such as enterprises, educational institutions, government agencies, etc., which can not only improve communication efficiency between users, reduce communication costs, but can also improve user events processing efficiency and office processing efficiency.

The mobile enterprise office platform can provide a call function between users, so that the user can initiate a call to other users based on the personal number or initiate a call to other users based on the pre-configured public number of the community.

However, when the originating party initiates a call, if the target object does not store the originating party's calling number, it is difficult to distinguish the originating party's identity and the calling destination by the calling number, and it can be easily judged as a harassing call by mistake, causing the call to fail.

### SUMMARY

In view of this, the present disclosure provides a call prompting method, apparatus, and system, which can perform on-demand writing of a call number to be identified and its identification information and achieve accurate identification of the incoming call number. This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer.

To achieve the above objective, the present disclosure provides the technical solutions described herein.

According to an aspect of the present disclosure, a call prompting system may be provided, including: an initiator, a server, and a target object. The initiator may send a call request to the server. The server may send a push message to the target object according to the received call request, where the push message includes a call number associated with an initiator and a corresponding call number description information. The target object may receive the push message and obtain the call number and the corresponding call number description information included in the push message to display the call number description information in an incoming call interface corresponding to the call number.

According to another aspect of the present disclosure, a call prompting method may be provided, including: receiving a call request from an initiator at a server; and sending, by the server, a push message to a target object of the call request, where the push message includes a call number associated with the initiator and corresponding call number description information, so that the target object displays the corresponding call number description information on an incoming call interface upon receiving the call request associated with the call number.

According to yet another of the present disclosure, a call prompting method may be provided, including: receiving, at a server, a call request from an initiator; and sending, by the server, a push message to a target object of the call request, where the push message includes a pre-configured call number associated with the initiator and corresponding call number description information, so that the target object displays the corresponding call number description information on an incoming call interface upon receiving the call request associated with the pre-configured call number.

According to yet another aspect of the present disclosure, a call prompting method may be provided, including: receiving, at a server, a call request from an initiator; and sending, by the server, a call number associated with the initiator and corresponding number description information to a target object of the call request, so that the target object displays the corresponding call number description information on an incoming call interface upon receiving the call request associated with the call number.

According to yet another aspect of the present disclosure, a call prompting method may be provided, including: receiving, at a server, a call request from an initiator; and sending, by the server, a call request based on a call number associated with the initiator and a prompt message including call number description information to a target object of the call request, so that the target object displays the corresponding call number description information on an incoming call interface upon receiving the call request associated with the call number.

According to yet another aspect of the present disclosure, a call prompting method may be provided, including: receiving, at a target object, a push message, wherein the push message is generated by a server according to a received call request from an initiator, and the call request is initiated based on the call number corresponding to the initiator; and obtaining, by the target object, the call number and corresponding call number description information included in the push message to display the call number description information in an incoming call interface corresponding to the call number.

According to yet another aspect of the present disclosure, a call prompting method may be provided, including: receiving, at a target object, a call number and corresponding number description information sent by a server, wherein the call number and corresponding number description information are obtained by the server upon receiving a call request from an initiator; and displaying, by the target object, the call number description information in an incoming call interface corresponding to the call number.

According to yet another aspect of the present disclosure, a call prompting method may be provided, including: receiving, at a target object, a call request and a prompt message sent by a server when the server may receive the call request from an initiator associated with a call number, wherein the prompt message includes call number description information corresponding to the call number; and displaying, by the target object, the call number description information in an incoming call interface corresponding to the call request.

According to yet another aspect of the present disclosure, a call prompting apparatus may be is provided, including: a first request receiving unit, configured to enable a server to receive a call request from an initiator; and a first message sending unit, configured to send, by the server, a push message to a target object of the call request, where the push message includes a call number associated with the initiator and corresponding call number description information, so that the target object displays the corresponding call number description information on an incoming call interface upon receiving the call request associated with the call number.

According to yet another aspect of the present disclosure, a call prompting apparatus may be provided, including: a second request receiving unit, configured to enable a server to receive a call request from an initiator; and a second message sending unit, configured to send, by the server, a push message to a target object of the call request, where the push message includes a pre-configured call number and a corresponding call number description information associated with the initiator, so as to enable the target object to display the corresponding call number description information on an incoming call interface upon receiving the call request associated with the pre-configured call number.

According to yet another aspect of the present disclosure, a call prompting apparatus may be provided, including: a third request receiving unit, configured to enable a server to receive a call request from an initiator; and a third message sending unit, configured to send, by the server, a call number associated with the initiator and corresponding call number description information to a target object of the call request, so that the target object displays the corresponding call number description information on an incoming call interface upon receiving the call request associated with the call number.

According to yet another aspect of the present disclosure, a call prompting apparatus may be provided, including: a fourth request receiving unit, configured to enable a server to receive a call request from an initiator; and a fourth message sending unit, configured to send, by the server, a call request based on a call number associated with the initiator and a prompt message including number description information to a target of the call request, so that the target object is at the location The call number description information is shown in the incoming call interface corresponding to the call request.

According to yet another aspect of the present disclosure, a call prompting apparatus may be provided, including: a first receiving unit, configured to enable a target object to receive a push message, wherein the push message is generated by a server according to a received call request from an initiator, and the call request is based on a call number corresponding to the initiator; and an acquiring unit, configured to acquire, by the target object, the call number and corresponding call number description information included in the push message, and to display the call number description information in an incoming call interface corresponding to the call number.

According to yet another aspect of the present disclosure, a call prompting apparatus may be provided, including: a third receiving unit, configured to enable a target object to receive a call number sent by a server and corresponding call number description information when the server may receive a call request initiated by an initiator associated with the call number, the call number and the call number description information being sent by the server to the target object, so that the target object displays the call number description information in an incoming call interface corresponding to the call number.

According to yet another aspect of the present disclosure, a call prompting apparatus is provided, including: a fourth receiving unit, configured to enable a target object to receive a call request and the a prompt message sent by a server when the server may receive a call request initiated by an initiator associated with the call number, wherein the prompt message includes call number description information corresponding to the call number; and a display unit, configured to display, by the target object, the call number description information in an incoming call interface corresponding to the call request.

As can be seen from the above technical solutions, the present disclosure sends the call number and the call number description information adopted by the initiator to the target object, so that the target object can accurately identify the call number according to the same and display the corresponding number description information. The target object can determine the identity information of the initiator and the purpose of the call based on the call number description information to avoid the initiator being misidentified as a harassing call party, and to improve the communication efficiency between the initiator and the target object. Meanwhile, since the call number and the corresponding call number description information is sent to the target object only when the call request is received, the on-demand writing of the identification number and its identification information can be achieved at the target object with no need to pre-write a large volume of call numbers and the identification information to the target object. Therefore, the amount of stored data at the target object can be strictly controlled, which can avoid the unreasonable occupation of the storage space and improve the recognition efficiency of the caller number.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example schematic diagram of a call prompting scheme of a related art.

FIG. 2 illustrates an example schematic diagram of another call prompting scheme of a related art.

FIG. 3A illustrates an example flowchart of a method for prompting a call on a server side according to an embodiment of the present disclosure.

FIG. 3B illustrates an example flowchart of a method for calling a call on a server side according to another embodiment of the present disclosure.

FIG. 3C illustrates an example flowchart of a method for calling a call on a server side according to another embodiment of the present disclosure.

FIG. 3D illustrates an example flowchart of a method for calling a call on a server side according to another embodiment of the present disclosure.

FIG. 4A illustrates an example flowchart of a method for prompting a call on a client side according to an embodiment of the present disclosure.

FIG. 4B illustrates an example flowchart of a method for prompting a call on a client side according to another embodiment of the present disclosure.

FIG. 4C illustrates an example flowchart of a method for prompting a call on a client side according to another embodiment of the present disclosure.

FIG. 5 illustrates an example schematic structural diagram of a call prompting system according to an embodiment of the present disclosure.

FIG. 6 illustrates an example schematic diagram of functional modules of an electronic device according to an embodiment of the present disclosure.

FIG. 7 illustrates an example flowchart of a call prompting method according to an embodiment of the present disclosure.

FIG. 8 illustrates an example schematic diagram of a call initiating interface according to an embodiment of the present disclosure.

FIG. 9 illustrates an example schematic diagram of functional modules of an electronic device for call prompting according to an embodiment of the present disclosure.

FIG. 10 illustrates an example schematic diagram of an incoming call reminder interface according to an embodiment of the present disclosure.

FIG. 11 illustrates an example schematic diagram of functional modules of an electronic device for call answering according to an embodiment of the present disclosure.

FIG. 12 illustrates an example schematic diagram of an electronic device on a server side according to an embodiment of the present disclosure.

FIG. 13 illustrates an example block diagram of a server-side call prompting apparatus according to an embodiment of the present disclosure.

FIG. 14 illustrates an example block diagram of a server-side call prompting apparatus according to another embodiment of the present disclosure.

FIG. 15 illustrates an example block diagram of a server-side call prompting apparatus according to another embodiment of the present disclosure.

FIG. 16 illustrates an example block diagram of a server-side call prompting apparatus according to another embodiment of the present disclosure.

FIG. 17 illustrates an example schematic diagram of an electronic device on a client side according to an embodiment of the present disclosure.

FIG. 18 illustrates an example block diagram of a client-side call prompting apparatus according to an embodiment of the present disclosure.

FIG. 19 illustrates an example block diagram of a client-side call prompting apparatus according to another embodiment of the present disclosure.

FIG. 20 illustrates an example block diagram of a client-side call prompting apparatus according to another embodiment of the present disclosure.

### DETAILED DESCRIPTION

Numerous specific details are set forth in the description below in order to provide a thorough understanding of the invention. However, the present disclosure can be implemented in many other ways than those described herein, and a person skilled in the art can make a similar modification without departing from the spirit of the disclosure, and thus the disclosure is not limited by the specific embodiments disclosed below.

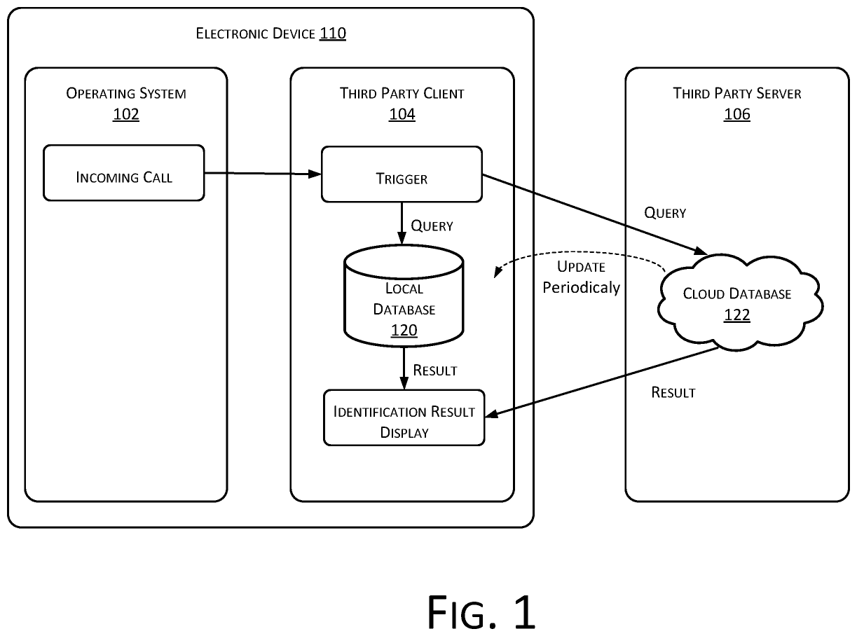

FIG. 1 illustrates an example schematic diagram of a call prompting scheme of a related art.

As shown in FIG. 1, an operating system 102 may be implemented on an electronic device 110. A client of a third-party application may be also installed on the electronic device 110, i.e., a third-party client 104. The operating system 102 and the third-party client 104 as shown in FIG. 1 may both belong to a local side of the electronic device 110. A third-party server 106, i.e., the server of the above-mentioned third-party application may belong to a cloud side of the electronic device 110. For the electronic device 110 shown in FIG. 1, when the operating system 102 running on the electronic device 110 detects an incoming call, the operating system 102 may allow the third-party client 104 to capture a corresponding call number and trigger a query operation on the call number to identify the call number description. The third-party client 104 can perform a local query on a local database 120 on the electronic device 110, or the third-party client 104 may upload the call number to the third-party server 106 and the third-party server 106 may perform a cloud query in a cloud database 122. The recognition result for the call number may be obtained according to at least one of the local query result based on the local database 120 and the cloud query result based on the cloud database 122, and a prompt message may be prompted in a corresponding call reminder interface. The local database 120 on the electronic device 110 is not subject to any restrictions of the operating system 102 and may be periodically updated or updated by a third-party server 106. Meanwhile, the cloud database 122 at the third-party server 106 has a larger amount of data storage, which can be implemented for accurate call number recognition operation.

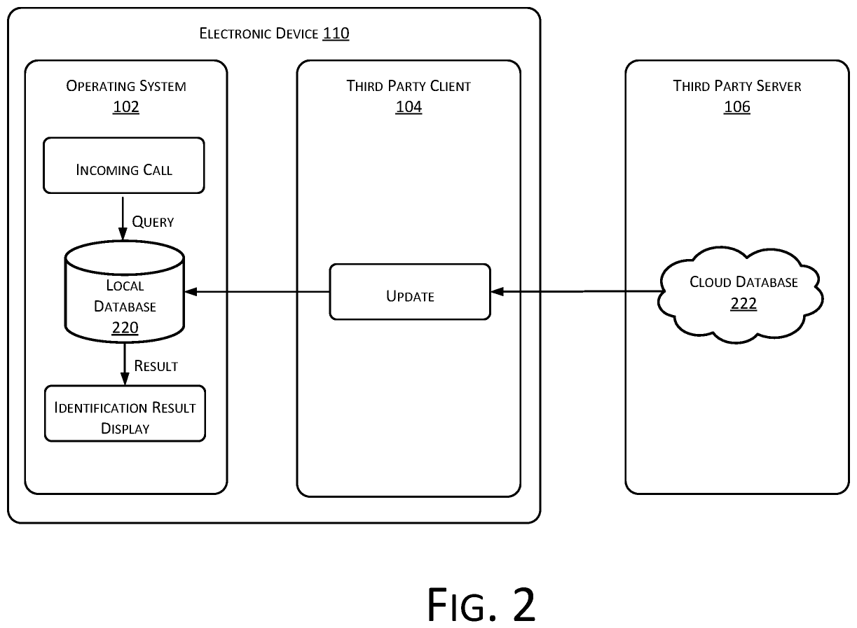

However, when implementing the call prompting scheme shown in FIG. 1, the following premise may have to be met: the operating system 102 opens the access right to the incoming call number to the third-party client 104. For operating systems such as Android developed by Google, third-party clients can obtain the above permissions to implement the call prompting scheme shown in FIG. 1. For an operating system such as iOS developed by Apple, the third-party client cannot obtain the above-mentioned permission, and thus the call prompt scheme shown in FIG. 1 cannot be implemented, and the call prompt scheme shown in FIG. 2 may be adopted.

As shown in FIG. 2, the operating system 102 may create a system local database 220 locally on the electronic device 110 and open the operation authority of the system local database 220 to the third-party client 104, so that the third-party client 104 can store the call number identification data to the system local database 220 of the system. After the system detects the incoming call, the operating system may perform a query operation on the system local database 220 of the system to obtain a recognition result of the incoming call number.

Although the third-party server 106 can push the update of the call number identification data to the third-party client 104, and the third-party client 104 can update the system local database 220, the local database system 220 may have a limitation on the amount of data storage. For example, only tens of thousands of call number identification information items can be written on the system local database 220, which are much smaller than the amount of data supported by the local database 120 created by the third-party client 104 shown in FIG. 1. The storage space of the system local database 220 even cannot be compared with hundreds of millions or even larger number of the identification information items stored in a cloud database 222, resulting very limited effect of recognizing the call number of the schemed illustrated in FIG. 2, and therefore, it is often impossible to accurately identify most of the call numbers.

Further, in the call prompting schemes shown in FIG. 1 and FIG. 2, a large number of call number identification data needs to be pre-stored in a local database 120 or a system local database 122 on the electronic device, and the call number is identified according to the stored call number identification data. Quite often, most information of the stored call number identification data is not used, resulting in an unwarranted waste of storage space for electronic devices.

Therefore, the present disclosure solves the above-mentioned technical problems existing in the related art by improving the call prompting scheme in the related art. In order to further illustrate this disclosure, the examples are provided herein.

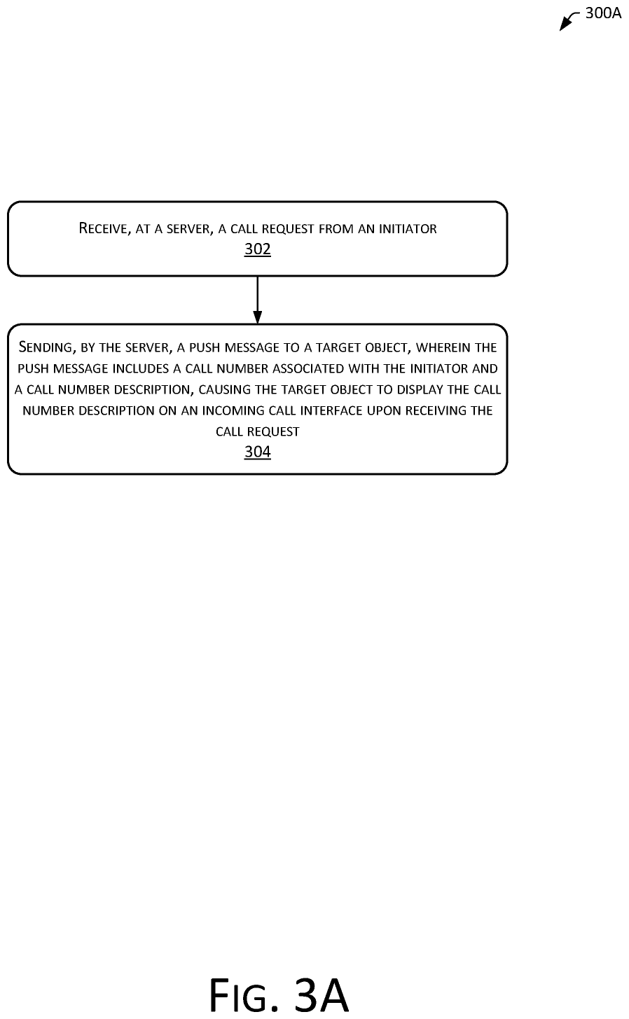

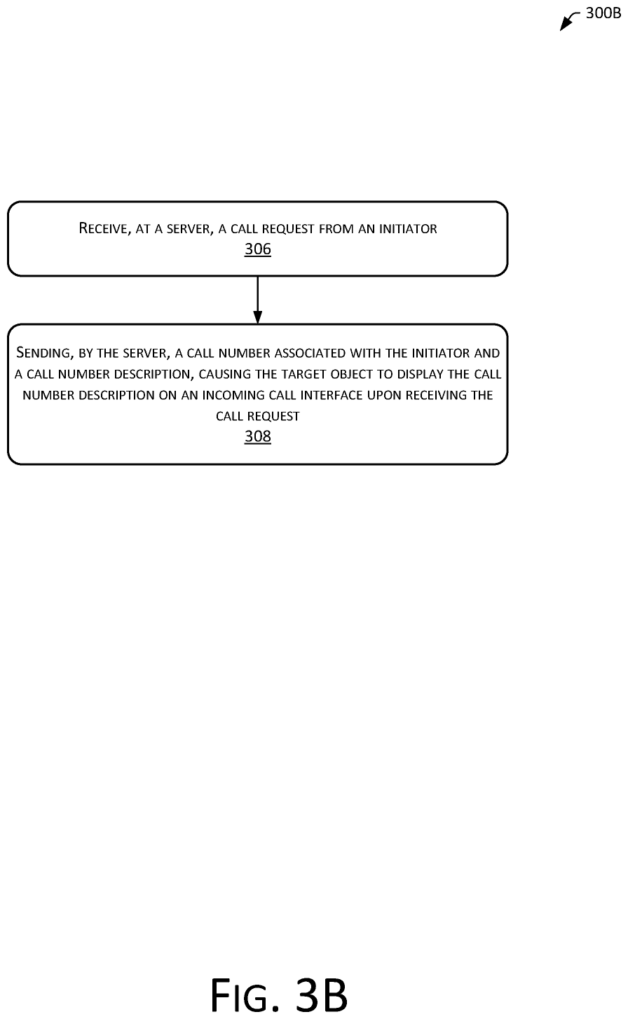

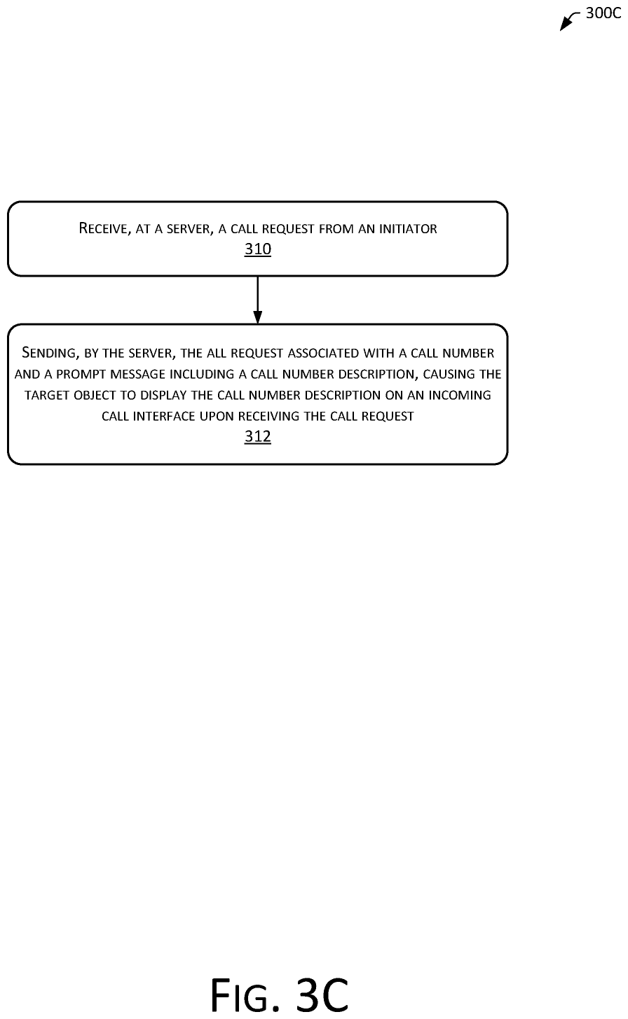

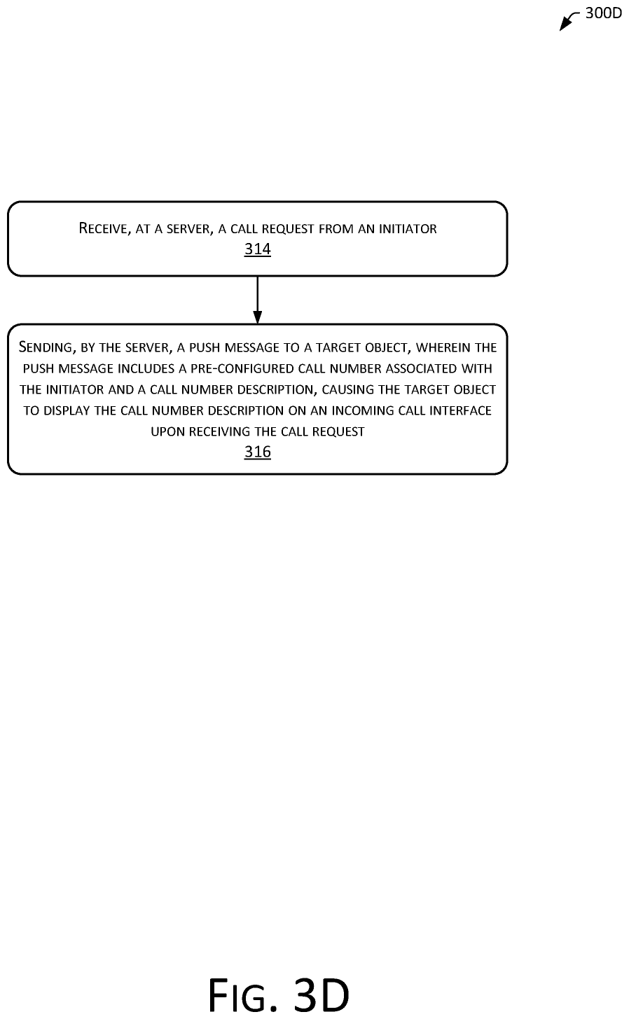

FIG. 3A illustrates an example flowchart of a method for prompting a call on a server side according to an embodiment of the present disclosure.

As shown in FIG. 3A, the method 300A may be applied to a server, and include the following steps described herein.

In step 302, the server may receive a call request from an initiator. In embodiments, the server may be the server of the mobile enterprise office platform. The mobile enterprise office platform may not only implement the communication function, but also be used as an integrated function platform for many other functions, such as for approval events (e.g., approval for absence, approval for office supplies, financial and other approval events), attendance events, task events, log events, ordering, purchasing, and other external events of the enterprise, this disclosure does not limit this.

In embodiments, mobile enterprise office platforms may be hosted in instant messaging applications in related technologies, such as enterprise instant messaging (EIM) applications, for example, Skype For Business®, Microsoft Teams®, Yammer®, Workplace®, Slack®, Enterprise WeChat®, Shares®, Enterprise Fetion®, Enterprise Letter®, etc. It should be understood that the instant messaging function is only one of the communication functions supported by the mobile enterprise office platform. The enterprise office platform can also implement more functions other than those described above and will not be described herein.

In step 304, the server may send a push message to a target object, wherein the push message includes a call number associated with the initiator and a call number description, causing the target object may receive to display the call number description on an incoming call interface upon receiving the call request.

In embodiments, the server may send a push message to an operating system server corresponding to an operating system of the target object, so that the push message may be pushed by the operating system server to the target object. For example, when the operating system of the target object is an iOS system, the operating system server may be a server implemented on an Apple Push Message Services (APNS), that is, the server may send a push message to the APNS, and the APNS may further send the push message to the corresponding target object.

In embodiments, the server may determine whether the target object stores the call number and the call number description; wherein, when it is determined that the call number and the call number description are not stored, the server may generate the push message including the call number and the call number description. When it is determined that the call number and the call number description are stored, the server does not need to send the call number and the call number description, so the push message may not include the call number and the call number description, thereby reducing the data transmission amount, improving the response speed to call requests and facilitating the establishment of calls.

There are various implementations to determine whether the target object stores the call number and the call number description.

In one implementation, the server may determine whether the target object stores the call number and corresponding call number description information. That is, as long as the target object stores the call number and corresponding call number description, without confirming whether the call number description is consistent with the stored corresponding call number description information, the server may determine that the target object stores the call number and the call number description, and the problem that the call number description may be updated may be ignored.

In another implementation, the server may further determine whether the stored corresponding call number description information is the latest information when the target object stores the call number and the corresponding call number description information, thereby solving the problem that the call number description information may be updated. When it is determining that the corresponding call number description information is the latest information, the server may determine that the target object stores the call number and the call number description information.

The server may determine, in various ways, whether the target object stores the call number and the call number description information

In one implementation, the server may query historical data to determine whether the target object stores the call number and the call number description information. For example, when the historical data includes a push message record, the server may determine whether to send the push message to the target object according to the push message record.

The push message record may record a push target and a push reason. If the push target is the target object, and the push reason is that the server may receive a call request based on the call number, the server may determine that the call number and the call number description information has been sent to the target object. That is, the target object is determined to have stored the call number and the call number description information and the problem that the call number description information may be updated may be ignored.

In another implementation, the push message record may record a push target, a push reason, and a push content. If the push target is the target object, and the push reason is that the server may receive a call request based on the call number, the server may further determine whether the push content is describing the information for the call number. If it is determined that the push content is the call number description information, the target object may be determined to have stored the call number and the call number description information, thereby solving the update problem that the call number description information may occur.

In another implementation, the server may send an inquiry message to the target object to determine whether the call number and the call number description information are stored by the target object, and the server may determine whether the call number and the call number description information are stored by the target object according to the inquiry result returned by the target object.

When the call number is included in the inquiry message, the target object may determine whether the call number and the corresponding call number description information are stored. That is, as long as the target object stores the call number and the corresponding call number description information, without confirming whether the call number description information is consistent with the stored corresponding call number description information, the target object may determine that the call number and the call number description information are stored therein, and ignore the problem that the call number description information may be updated.

In another implementation, when the inquiry message includes the call number and the call number description information, the target object may determine whether the call number and corresponding call number description information are stored, and whether the stored corresponding call number description information is consistent with the call number description information. When the call number and the corresponding call number description information are present, and the stored corresponding call number description information is consistent with the call number description information, the target object may determine that the call number and the call number description information are stored, thereby solving the call number description information may have an updated issue.

There may be multiple example sources of information for the call number description information included in the push message.

In an implementation, the server may pre-store the call number description information corresponding to the call number, and the server may generate the push message according to the pre-stored call number description information and send the push message to the target object.

In another implementation, the server may not pre-store the call number description information corresponding to the call number, and the server may receive the call number description information sent by an initiator and generate the push message accordingly. The push message may be further sent to the target object.

In this implementation, the call number used by the initiator may be a pre-configured call number, and the initiator may select the call number and pre-configure it as its own corresponding number. Alternatively, the server may pre-set the call number according to a preset condition and configure the call number corresponding to the initiator. For example, if the call number is a public number of the community to which the initiator belongs, the server may pre-configure the public number to correspond to the initiator when the initiator uses the group call function of the community to which the initiator belongs.

In an implementation, when the call number is the personal number of the initiator, the call number description information is the personal description information of the initiator. For example, the personal description information may include the name of the initiator, the group to which the initiator belongs, the position, etc., allowing the target object to display the personal description information on the incoming call interface to prompt the target object.

In another implementation, when the call number is a public number of the group to which the initiator belongs, the call number description information is group description information of the community to which the initiator belongs. For example, the group description information may include a community name, the nature of the group, industry classification, etc., allowing the target object to display the group description information in the incoming call interface to prompt the target object. The public number may be a virtual ID resource applied by the server to the operator network and may not necessarily need to be bound to a mobile phone or a wired telephone. When a public number is applied for by any group, the public number may be used. The public number may be associated with any one of the groups, so that the group members in the group can use the public number uniformly, thereby facilitating unified configuration and management of the communication resources. In a situation when the initiator belonging to the group uses the public number of the group to initiate a call request to a target object, the contact information of the initiator (including the initiator's personal number and number description information) is stored in the device address book of the target object, but the public number and its number description information are not stored (and even stored in the past, the public number corresponding to the group may change at any time or periodically, resulting in invalidation of the originally stored information), the call number identification and incoming call prompt from the public number cannot be performed based on the device address book. This disclosure is intended to solve the solution to this technical problem.

In this embodiment, the push message may be used to instruct the target object to store the call number and the call number description information to the call number identification information library of the target object, so that the target object may obtain the call number description from the call number identification information library when subsequent call requests are received from a same call number and display the call number description on an incoming call interface. The call number identification information library may be provided by the operating system of the target object; however, the present disclosure is not intended to be limiting. The call number identification information library may be stored in any form. For example, the call number identification information library may be in the form of a database, which is not limited by this disclosure.

In this embodiment, after sending the push message to the target object, the server may determine the call number and the call number description information have been stored to the target object upon receiving the storage success message returned by the target object. The call number identification information library enables the target object to effectively identify the initiators incoming call and display the call number description information in the corresponding incoming call interface. Therefore, the server can perform a call operation based on the call number to the communication number of the initiator and the target object, respectively, through a communication network, thereby establishing a call between the initiator and the target object.

In this embodiment, the call number library associated with an application corresponding to the target object may be stored on the server or the target object. Each time the call number identification information database of the target object is updated, the operations include: updating call number library associated with the application, for example, writing the call number and the call number description information into the call number library associated with the application, and then importing the data in the call number library associated with the application into the caller number identification information database, so that the call number library associated with the application can always maintain data consistency with the call number identification information database. Then, when the call number library associated with the application corresponding to the target object is maintained on the server, the call number library associated with the application can be queried to determine whether the call number and the call number description information are included in the call number identification information database. When the call number library associated with the application corresponding to the target object is maintained on the target object, the target object can query the call number library associated with the application by itself or according to the inquiry request sent by the server to determine whether the call number and the call number description information are included in the call number identification information database. The application may be a third-party application implemented on an electronic device. In embodiments, when the device operating system with which the target object is associated, has strong authority control on the third-party application, if the call number identification information database is provided by the device operating system, and the target object does not have permission to access the call number identification information database, the target object can query the call number library associated with the application, and can also determine whether the call number and the call number description information are included in the call number identification information database.

In this embodiment, after receiving the push message, the target object may process the push message by the target device operating system, especially when the call number identification information database is provided by the device operating system and store the call number and the call number description information in the call number identification information database. Alternatively, the push message may be processed by the target object, which is not limited in this disclosure.

The above-mentioned device operating system such as iOS has strict authority control on the third-party application, so that the target object cannot directly identify the call number and show the recognition result, i.e., the call number description information, in the in-coming call interface. However, if the device operating system opens the write permission to the call number identification information database to the target object, the target object may store the call number and the call number description information to the call number identification database based on the foregoing technical solution. The call number identification database enables the device operating system to perform the call identification based on the call number identification information database and ensures that the call number used by the initiator is effectively identified and the corresponding call number description information is displayed on the in-coming call interface. The effect can be equivalent or similar to the call number operation performed directly by the target object. In embodiments, if the operating system of the device is the above-mentioned operating system such as Android, that is, the operating system does not restrict the third-party application from identifying the call number, the target object may identify the call number associated with the initiator based on the call number identification information database provided by itself. The call number may be effectively identified, and the call number description information may be displayed on the corresponding incoming call interface. Regardless of the device operating system, the call prompting scheme based on the present disclosure can avoid writing a large amount of data (i.e., associated number and number description information) in advance at the target object, thereby reducing unnecessary space occupation. The present disclosure also helps to improve the recognition efficiency of the call number.

FIG. 3B illustrates an example flowchart of a method for calling a call on a server side according to another embodiment of the present disclosure.

As shown in FIG. 3B, the method 300B may be applied to a server, and may include the following steps described herein.

In step 306, the server may receive a call request from an initiator.

In step 308, the server may send a call number associated with the initiator and a call number description to a target object, causing the target object to display the call number description on an incoming call interface upon receiving the call request.

In this embodiment, the server may separately send the call number and the call number description information to the target object, so that when the target object subsequently may receive the call request associated with the call number, the call number description information corresponding to the call number can be determined (i.e., the caller number recognition is implemented). Identify) so that the call number description information can be shown in the incoming call interface.

In this embodiment, the server may determine whether the target object stores the call number and the call number description information. When it is determined that the call number and the call number description information are not stored, the server may send the call number and the corresponding number description information to the target object. When it is determined that the call number and the call number description information have been stored, the server may not send the call number and the corresponding number description information to the target object. On the one hand, it can avoid unnecessary interaction and processing; and on the other hand, it can improve the response speed of the call request and facilitate the establishment of the call.

The understanding and implementation manner of “whether the target object stores the call number and the call number description information,” the information source of the call number description information, other technical features related to the call number, the target object description information for the call number, the processing procedure, etc., reference may be made to the embodiment shown in FIG. 3A, and details are not described herein again.

FIG. 3C illustrates an example flowchart of a method for calling a call on a server side according to another embodiment of the present disclosure.

As shown in FIG. 3C, the method 300C may be applied to the server, and may include the following steps described herein.

In step 310, the server may receive a call request from the initiator.

In step 312, the server may send a call request associated with a call number and a prompt message including a call number description to a target object, causing the target object to display the call number description on an incoming call interface upon receiving the call request.

In this embodiment, the server may send a call request and a prompt message to the target object respectively, where the call request is used to initiate a call to the target object, and the prompt message is used to notify the target object of the call number description information for the target object, causing the target object to identify the call number corresponding to the initiator and display the call number description information corresponding to the call number in the incoming call interface.

In this embodiment, the server may determine whether the target object stores the call number and the call number description information. When it is determined that the call number and the call number description information are not stored, the prompt message may include the call number description information corresponding to the call number; and when it is determined that the call number and the call number description information have been stored, the server may not send the foregoing prompt message to the target object, and on the one hand, avoiding unnecessary interaction and processing. The process, on the other hand, can improve the response speed to the call request and facilitate the establishment of the call.

The understanding and implementation manner of “whether the target object stores the call number and the call number description information,” the information source of the call number description information, other technical features related to the call number, the target object description information for the call number, the processing procedure, etc., reference may be made to the embodiment shown in FIG. 3A, and details are not described herein again.

FIG. 3D illustrates an example flowchart of a method for calling a call on a server side according to another embodiment of the present disclosure.

As shown in FIG. 3D, the method 300D may be applied to the server, and may include the following steps described herein.

In step 314, the server may receive a call request from an initiator.

In step 316, the server may send a push message to a target object, wherein the push message includes a pre-configured call number associated with the initiator and a call number description, causing the target object to display the call number description on an incoming call interface upon receiving the call request.

In this embodiment, the initiator may initiate a call request based on a pre-configured call number, so that the server may send a push message to the target object including the pre-configured call number and the corresponding call number description information, causing the target object to display the corresponding call number description information on an incoming call interface.

In this embodiment, the server may determine whether the target object stores the pre-configured number and the call number description information. When it is determined that the pre-configured number and the call number description information are not stored, the pre-configured number and the call number description information may be included in the push message; and when it is determined that the pre-configured number and the call number description information have been stored, the server may not send the above-mentioned push message to the target object, and thus, avoiding unnecessary interaction and processing on the one hand. On the other hand, the process can improve the response speed of the call request and facilitate the establishment of the call.

The understanding and implementation manner of “whether the target object stores the call number and the call number description information,” the information source of the call number description information, other technical features related to the call number, the target object description information for the call number, the processing procedure, etc., reference may be made to the embodiment shown in FIG. 3A, and details are not described herein again.

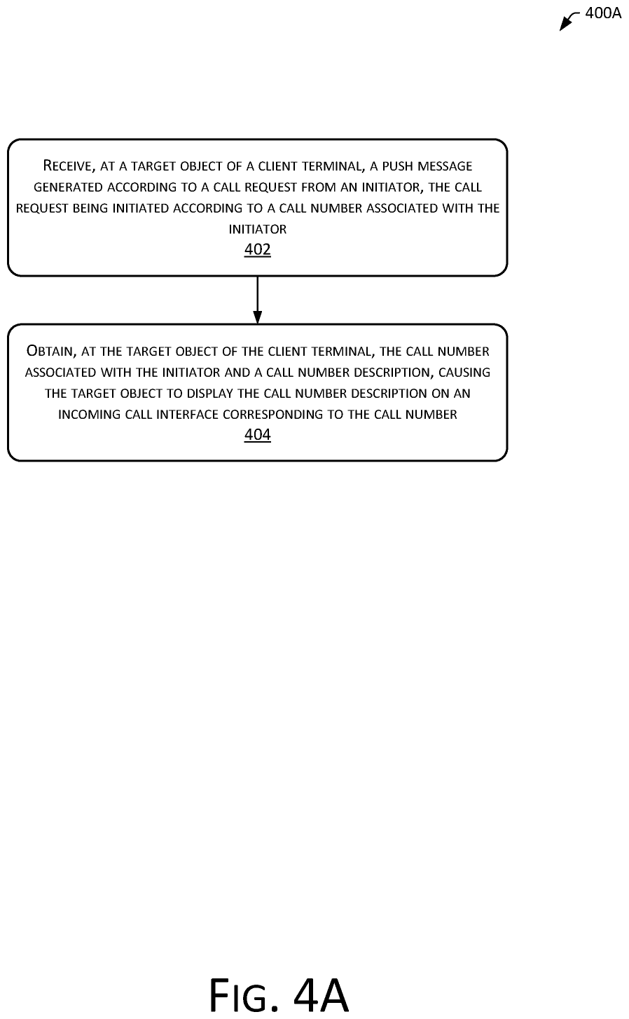

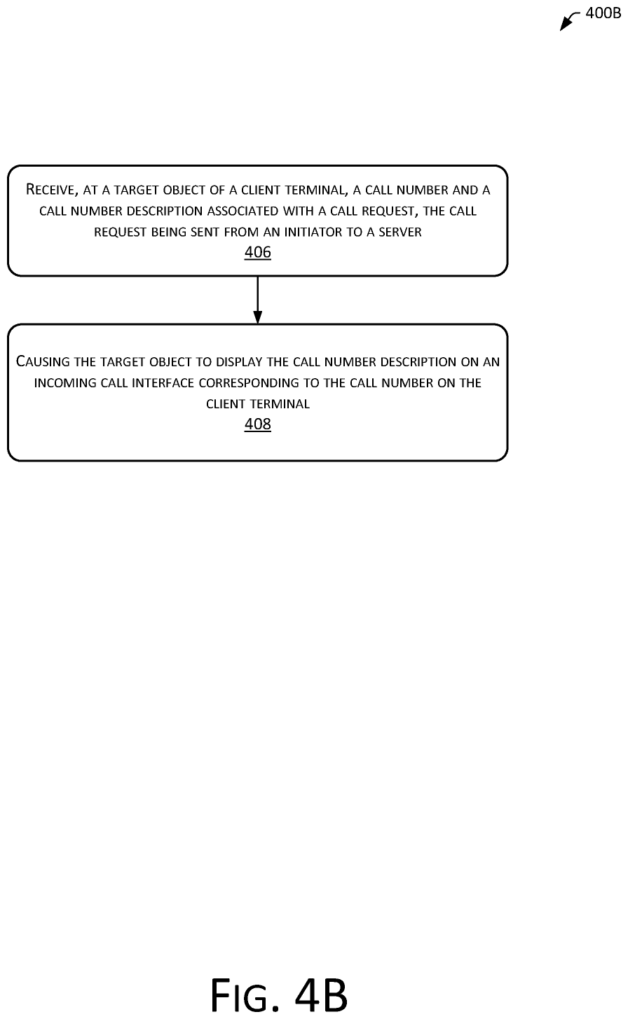

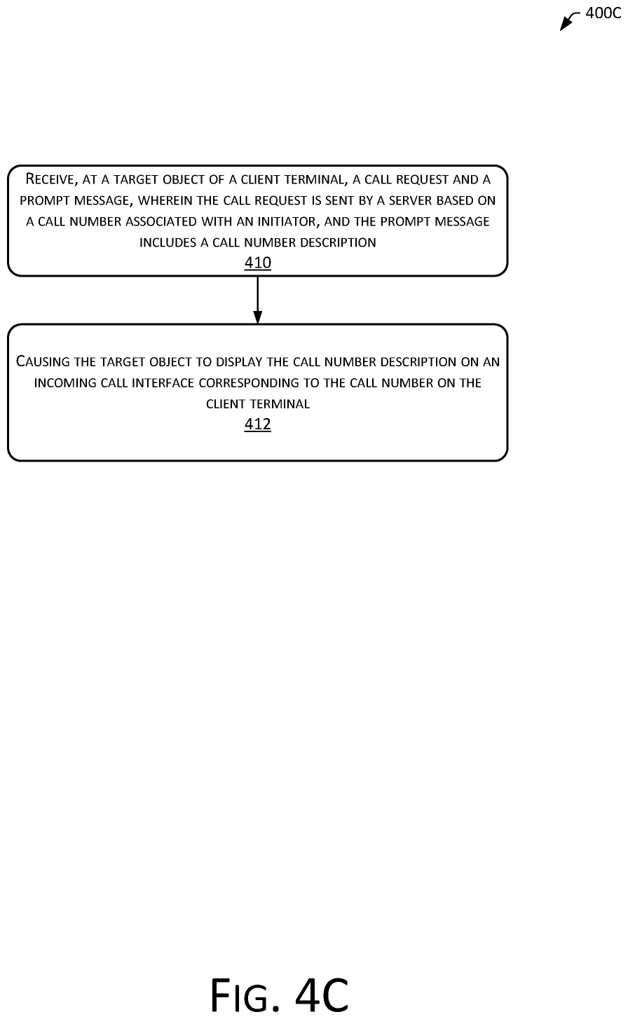

FIG. 4A illustrates an example flowchart of a method for prompting a call on a client side according to an embodiment of the present disclosure.

As shown in FIG. 4A, the method 400A may be applied to a target object and may include the following steps described herein.

In step 402, a target object may receive a push message, the push message being generated according to a call request from an initiator, the call request being initiated according to a call number associated with the initiator.

In this embodiment, an application of the target object may be pre-installed on an electronic device (i.e., the electronic device used by the target object, that is, the target device), so that the target object can be started and run on the electronic device. When using an online “client” such as HTML5 technology, the target object can be obtained and run without installing the corresponding application on the electronic device.

In an embodiment, the push message may be generated by the server, and sent by the server to the operating system server corresponding to the target operating system of the target device, and then the target object may receive the push message pushed by the operating system server.

In embodiments, the target object may be configured with a push message receiving module matched to the device operating system running on the target device. Taking the device operating system as the iOS system as an example, the push message receiving module may be built by using a Pushkit framework, and by using the push message receiving module to register the receiving request of the push message on the iOS system in advance, the iOS system can be utilized. The Pushkit framework may provide an open data push service, so that when the APNS sends a push message sent by the server to the iOS system of the target device, the iOS system can deliver the push message to the push message receiving module based on the Pushkit framework. The push message receiving module may provide processing to other functional modules of the target object. For example, the other functional modules may include an application function module in the target object, and the application function module is equivalent to all application functions of the target object in the related art.

The push message receiving module may be configured in the target object, and the sending/receiving module may receive and transmit the push message, so that the target object does not need to establish and maintain a long connection with the server and can still receive and respond to the push message. It helps to reduce power consumption and save communication resources. Meanwhile, the push message receiving module can also actively evoke the target object (such as other functional modules of the target object) based on the received push message. For example, when the target object is in an inactivate state, the push message receiving module can activate the target object upon receiving the push message. Even if the user manually shuts down the target object, or the user restarts the target device, or the device operating system shuts down the target object for power reduction, release of running resources, or other reasons, the push message receiving module may actively invoke the target object to ensure timely response and processing of the push message, for example, storing the call number and the call number description information included in the push message to the call number description information database.

In another embodiment, the server may establish a long connection with the target object, so that the server may directly send the push message to the target object without being implemented based on the operating system server described above.

In step 404, the target object may obtain the call number associated with the initiator and a call number, causing the target object to display the call number description on an incoming call interface corresponding to the call number.

In this embodiment, the target object may store the call number and the call number description information to the target object's caller number identification information library, so that when there is a call request based on the call number, the caller number identification information library is used to obtain the call number description information corresponding to the call number, and the acquired call number description information is presented to the target object. The caller number identification information library may be provided by the target device operating system, which, however, is not limited in this disclosure. The call number identification information library may be stored in any form. For example, the call number identification information library may be in the form of a database, which is not limited in this disclosure.

In this embodiment, the target object may maintain a silent operation in the background of the device operating system by using a storage process or a storage thread to store the call number and the call number description information to the call number identification information library. The storage process or the storage thread may be invoked by the target object to store the call number and the call number description information to the call number identification information library. Then, the target object can maintain the silent state during the entire processing process for the push message, and the target object can be completely unaware during the entire processing process for the push message, so that the entire call process is more integrated for the target object on the target object side. The entire processing process for the push message is performed exactly during the existing call process, thus, avoiding the complexity of the call process. In addition, after the target object stores the call number and the call number description information to the call number identification information library, the storage process or the storage thread may be released to avoid continuous occupation of processing resources. The impact on the normal operation of the target device can be reduced.

In embodiments, the storage process for the call number and the call number description information may not be completely silent. For example, after obtaining the call number and the call number description information, the target object may display an interaction interface to the target object and perform a confirmation operation on the interaction interface at the target object (such as clicking “confirm” in the interaction interface). When the option or the confirmation is selected, the call number and the call number description information are stored in the call number identification information library, so that the target object actively participates in the storage process, thereby actively confirming or rejecting the storage of the call number and the call number description information.

In this embodiment, after the call number and the call number description information are stored in the call number identification information library, the target object may return a storage success message to the server to enable the service. The terminal may perform a call operation based on the call number to the communication number of the initiator and the target, respectively, by using a communication network, so as to prevent the target device from being unable to display the corresponding call number description information when the call request is initiated ahead of time and avoid excessive response delay to the initiator's call request.

In this embodiment, when the database clearing condition is met, the target object may actively clear the data stored in the call number identification information library, including the call number and the call number description information. For example, the database clearing condition may include: ending the call (i.e., storing the call number and number description information required for the current call before each call, and clearing after the call ends), and the predefined clearing cycle arrives (i.e., according to the predefined clearing period, periodically clear the call number identification database, etc.) By actively clearing the call number identification information library, it can avoid causing unwarranted occupation of the storage space of the target device and can also reduce the data items stored in the call number identification information library as much as possible when the target device is called, thereby improving the call number recognition efficiency and reducing the prompting delay.

In this implementation, the call number used by the initiator may be a pre-configured call number, and the initiator may select the call number and pre-configure it as its own corresponding number. Alternatively, the server may pre-set the call number according to a preset condition and configure the call number corresponding to the initiator. For example, if the call number is a public number of the community to which the initiator belongs, the server may pre-configure the public number to correspond to the initiator when the initiator uses the group call function of the community to which the initiator belongs.

In this embodiment, the target object may receive a query message sent by the server. The target object may determine, according to the query message, whether the target object stores the call number and the call number description information. And then the target object may return an inquiry result to the server, so that the server sends the inquiry result to the target object if the inquiry result is that the call number and the call number description information are not stored, causing the target object to send the push message.

In an implementation, when the call number is included in the inquiry message, the target object may determine whether the target stores the call number and corresponding call number description information without determining whether the call number description information is consistent with the stored call number description information. When it is determined that the call number and the corresponding call number description information are present, it may be determined that the target object stores the call number and the call number description information, and the problem that the call number description information may be updated is ignored.

In another implementation, when the inquiry message includes the call number and the call number description information, the target object may determine whether the target object stores the corresponding call number call number description information, and whether the stored corresponding call number information is consistent with the call number description information. When the call number and the corresponding call number description information are present, and the stored corresponding call number description information is consistent with the call number description information, the target object may determine that the target object stores the call number and the call number description information, thereby solving the problem that the call number description information may be updated.

FIG. 4B illustrates an example flowchart of a method for prompting a call on a client side according to another embodiment of the present disclosure.

As shown in FIG. 4B, the method 400B may be applied to the target object and may include the following steps described herein.

In step 406, the target object of a client terminal may receive a call number and a call number description associated with a call request, the call request being sent from an initiator to a server. When the server receives the call request initiated by the initiator based on the call number, the call number and the call number description information are sent by the server to the target object, causing the target object to display the call number description information in an incoming call interface corresponding to the call number.

In step 408, the target object of a client terminal may display the call number description on an incoming call interface corresponding to the call number on the client terminal

In this embodiment, the server may separately send the call number and the call number description information to the target object, so that when the target object subsequently may receive the call request associated with the call number, the call number description information corresponding to the call number can be determined (i.e., the caller number recognition is implemented). Identify) so that the call number description information can be shown in the incoming call interface.

In this embodiment, except for the differences in the sources of the call number description information, other technical solutions may be referred to the embodiment shown in FIG. 4A, and details are not described herein again.

FIG. 4C illustrates an example flowchart of a method for prompting a call on a client side according to another embodiment of the present disclosure.

As shown in FIG. 4C, the method 400C may be applied to the target object and may include the following steps described herein.

In step 410, the target object of a client terminal may receive a call request and a prompt message, wherein the call request is sent by a server based on a call number associated with an initiator, and the prompt message includes a call number description.

In step 412, the target object may display the call number description on an incoming call interface corresponding to the call number on the client terminal.

In this embodiment, the server may send a call request and a prompt message to the target object respectively, where the call request is used to initiate a call to the target object, and the prompt message is used to notify the target object of the call number description information for the target object, causing the target object to identify the call number corresponding to the initiator and display the call number description information corresponding to the call number in the incoming call interface.

In this embodiment, except for the differences in the sources of the call number description information, other technical solutions may refer to the embodiment shown in FIG. 4A, and details are not described herein again.

As can be seen from the above technical solutions, the present disclosure sends the call number and the call number description information adopted by the initiator to the target object, so that the target object can accurately identify the call number according to the same and display the corresponding number description information. The target object can determine the identity information of the initiator and the purpose of the call based on the call number description information to avoid the initiator being misidentified as a harassing call party, and to improve the communication efficiency between the initiator and the target object. Meanwhile, since the call number and the corresponding call number description information is sent to the target object only when the call request is received, the on-demand writing of the identification number and its identification information can be achieved at the target object with no need to pre-write a large volume of call numbers and the identification information to the target object. Therefore, the amount of stored data at the target object can be strictly controlled, which can avoid the unreasonable occupation of the storage space and improve the recognition efficiency of the caller number.

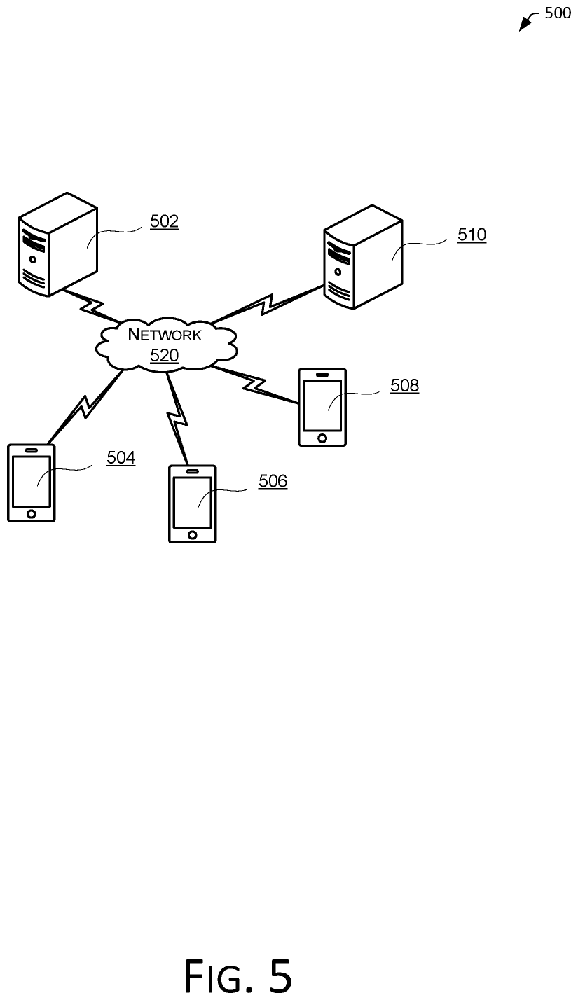

FIG. 5 illustrates an example schematic structural diagram of a call prompting system according to an embodiment of the present disclosure.

As shown in FIG. 5, the system 500 may include a server 502, a network 520, and a number of electronic devices, such as a cell phone 504, a cell phone 506 and a cell phone 508, and an operating system server 510.

The server 502 may be a physical server including a separate host, or the server 502 may be a virtual server hosted by the host cluster, or the server 502 may be a cloud server. During the executing process, the server 502 may execute a server-side program of an application to implement related business functions of the application. For example, when the server 502 executes the program of the mobile group office platform, the server side of the mobile group office platform can be implemented. In the technical solution of the present disclosure, the server 502 may cooperate with a client terminal running on the mobile phones 504-508 to implement an environment-aware collaborative processing solution.

Mobile phones 504-508 are just one type of electronic device that a user can use. In embodiments, users can also use electronic devices such as tablet devices, notebook computers, Personal Digital Assistants (PDAs), wearable devices (such as smart glasses, smart watches, etc.), etc. The present disclosure is not intended to be limiting. During operation, the electronic device can run a client-side program of an application to implement related business functions of the application. For example, when the electronic device runs a program of the mobile group office platform, the mobile device can be implemented as a client terminal of the group office platform.

For the network 520 that interacts between the mobile phones 504-508 and the server 502, various types of wired or wireless networks may be included. In an embodiment, the network 520 may include a Public Switched Telephone Network (PSTN) and the Internet. Meanwhile, the electronic devices such as the mobile phones 504-508 can also communicate with each other through the network 520, such as establishing a single-chat communication session between any two electronic devices; or, several electronic devices can participate in the same group chat communication session, thus, enabling any user to send a communication message to all other users in the group chat communication session through their own electronic devices. For example, when the group chat communication session is an inter-group communication session between multiple groups, groups in these groups members can conduct group chat communication through this cross-group communication session.

A long connection may be established between the server 502 and the mobile phones 504-508 via the network 520, so that the server 502 may transmit a push message or the like to the mobile phones 504-508 through the long connection. In embodiments, the server 502 and the mobile phones 504-508 do not (or cannot) establish a long connection, the server 502 may send a push message to the corresponding operating system server 510 according to the operating system running on the mobile phones 504-508. The push message may be sent by the operating system server 510 to the mobile phones 504-508.

For ease of understanding, the technical solution of the present disclosure is described by taking an enterprise instant messaging (IM) application as an example. In some examples, the enterprise instant messaging (IM) application may include Skype For Business®, Microsoft Teams®, Yammer®, Workplace®, Slack®, Enterprise WeChat®, Shares®, Enterprise Fetion®, Enterprise Letter®, etc. It is assumed that the mobile phone 504 and the mobile phone 506 are running the enterprise IM client, and the server 502 is running the enterprise IM server. The mobile phone 504 and the enterprise IM client on the mobile phone 506 are respectively registered with the registered accounts of different users. For example, the mobile phone 504 has registered account of the initiator, so that the mobile phone 504 is configured as the initiator device corresponding to the initiator. The IM client 1 corresponding to the initiator is registered on the mobile phone 504, and the registered account of the target object is registered on the mobile phone 506, so that the mobile phone 506 is configured as a target device corresponding to the target object. The mobile phone 506 is registered with the IM client 2 corresponding to the target object. When the initiator belongs to the enterprise A and the target object belongs to the enterprise B, the initiator can initiate a call request to the enterprise IM server on the server 502 through the IM client 1 running on the mobile phone 504, so that the initiator can utilize the office number corresponding to enterprise A to initiate a call to the target object. If the office number corresponding to enterprise A is not stored on the mobile phone 506, the mobile phone 506 can accurately identify and prompt the office number based on the technical solution of the present disclosure.

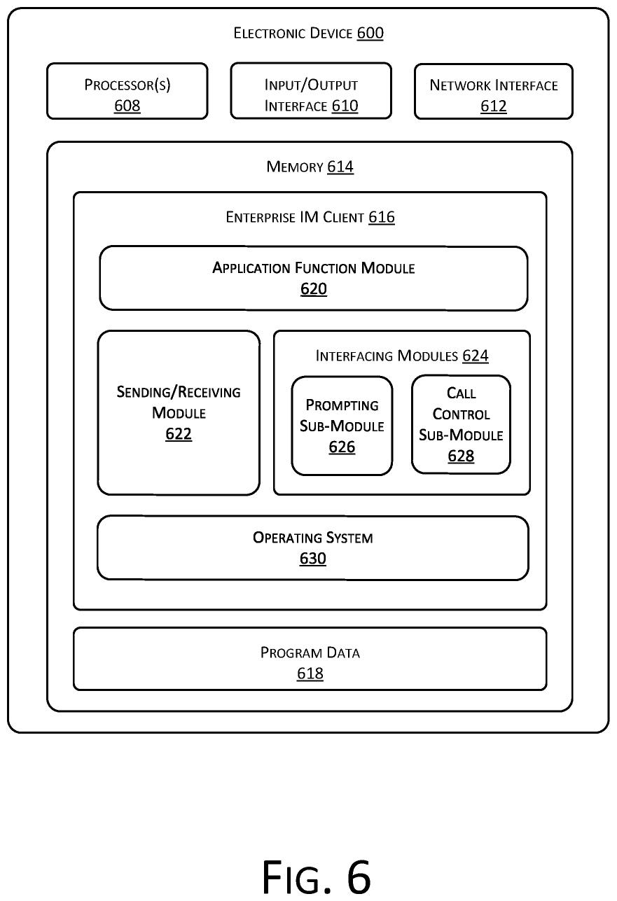

FIG. 6 illustrates an example schematic diagram of functional modules of an electronic device according to an embodiment of the present disclosure.

Any of the mobile phones 504-508 in FIG. 5 may be implemented on an electronic device 600 as shown in FIG. 6. The electronic device 600 may include an enterprise IM client 616 (for example, configured as the IM client 2 described above) and an operating system 630. The enterprise IM client 616 may further include an application function module 620, a sending/receiving module 622, and an interface module 624.

In an exemplary embodiment, assuming that the operating system used 630 by the mobile phone 506 is an iOS system, the sending/receiving module 622 may be a function module based on the Pushkit framework, and the interface module 624 may be a function module based on a Callkit framework, wherein the Pushkit The framework, the Callkit framework and the iOS system are provided by the same provider, so that the sending/receiving module 622 and the interface module 624 have relatively higher operational rights (compared to the application function module 620) for the iOS system to achieve the operational purpose of the present disclosure. The application function module 620 may be equivalent to the enterprise IM client in the related technology; that is, the enterprise IM client in the application may be based on the original enterprise IM client in the related technology and may integrate the sending/receiving module 622 based on the Pushkit framework and the interface module 624 based on Callkit framework.

In embodiments, the electronic device 600 may include processor(s) 608, an input/output interface 610, a network interface 612, and a memory 614.

The memory 614 may include a form of computer readable media such as a volatile memory, a random-access memory (RAM) and/or a non-volatile memory, for example, a read-only memory (ROM) or a flash RAM. The memory 614 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In embodiments, the memory 614 may include program modules of the enterprise IM client 616 and program data 618. The program modules the enterprise IM client 616 may include the application function module 620, the sending/receiving module 622, and the interface module 624 as described in the foregoing description.

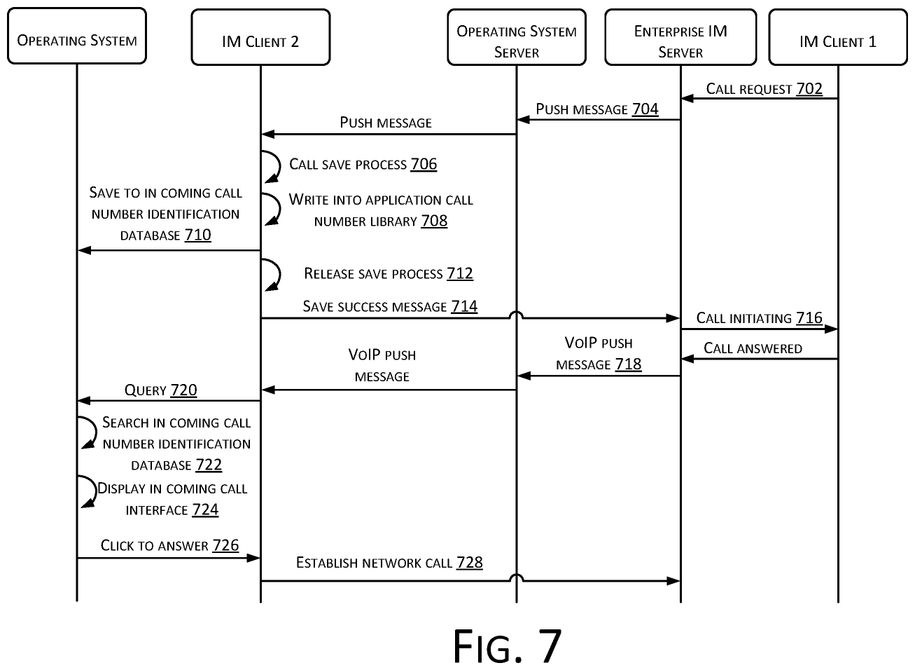

Based on the above-mentioned enterprise IM client, FIG. 7 illustrates an example flowchart of a call prompting method according to an embodiment of the present disclosure.

As shown in FIG. 7, the method 700 may include the following steps described herein.

In step 702, the initiator may initiate a call request for the target object to the enterprise IM server through the IM client 1 running on the mobile phone 504, and the call request is initiated based on the public number of the enterprise A to which the initiator belongs. The IM client 1 is logged in with the initiators corporate IM account.

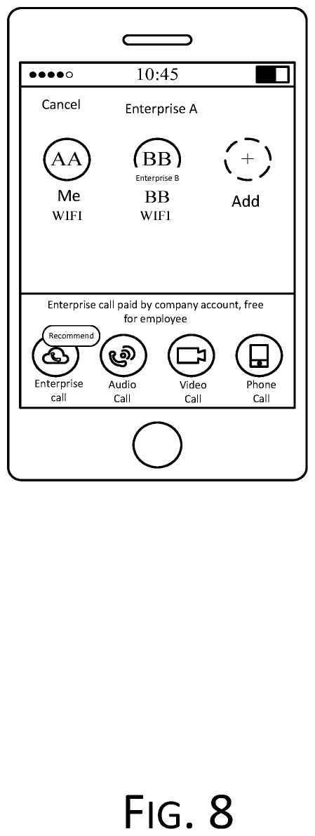

In this embodiment, the IM client 1 may provide a call initiation interface such as that shown in FIG. 8. In the call initiation interface, the initiator (assumed to be user AA) may select the user as the target object (assumed to be enterprise B, User BB), and by clicking “Enterprise Call” at the bottom of the call initiation interface, the public number is selected based on the enterprise A to which the initiator belongs, and a call request initiated for the target object is sent to the enterprise IM server. The initiator can also establish other types of calls with the target object through the “audio call,” “video call,” “phone call” included in the call initiation interface, and the details will not be enumerated here.

In this embodiment, for the mobile phone 504 used by the initiator, there is no operating system requirement, that is, the mobile phone 504 can adopt an operating system such as an Android device, iOS or any other type, which does not affect the implementation of the technology of the present disclosure.

In step 704, the enterprise IM server may send a push message to the corresponding operating system server according to the operating system on the mobile phone 506 used by the target object, and the operating system server may further push the push message to the IM running on the mobile phone 506, where the IM client 2 is logged in with the target enterprise IM account.

In this embodiment, assuming that the operating system of the mobile phone 506 is an iOS system, and the corresponding operating system server is configured on the APNS, the enterprise IM server may send a push message to the APNS, and the APNS may push the message to the IM client 2 running on the mobile phone 506. The transmission process of the above push message may also depend on the pre-processing steps described herein.

Based on the example schematic diagram of functional modules shown in FIG. 6, it can be understood that the application registration request is initiated by the application function module in the IM client 2 to the APNS, and the application registration request may include UDID (Unique Device Identifier, unique device identifier of the device) of the electronic device to which the IM client 2 belongs (i.e., the mobile phone 506) and the bundle identifier (application identifier) of the IM client 2 to indicate the identity of the IM client 2. Correspondingly, the APNS may encrypt the UDID and the bundle identifier according to the application registration request sent by the IM client 2 to generate a device key (device token) corresponding to the IM client 2. Then, the IM client 2 may include the device key in the key prompt message to notify the enterprise IM server of the device key.

Therefore, based on the foregoing pre-processing step, when the enterprise IM server receives the call request for the target object, if it is determined that the target object logs the account to the IM client 2 on the mobile phone 506, the enterprise IM server can push the message. The enterprise IM server may add a device key corresponding to the IM client 2 and send a push message containing the device key to the APNS, so that the APNS further sends the push message to the mobile phone 506 according to the device key included in the push message corresponding to the IM client 2.

In step 706, the IM client 2 may call save process.

In this embodiment, the push message may be first pushed to the sending/receiving module in the IM client 2, and the sending/receiving module may invoke the application function module of the IM client 2, and then the storage function process may be invoked by the application function module to save data.

In step 708, the storage process may extract the public number of the enterprise A and its number description information included in the push message and write the information to the application call number library and maintained by the IM client 2.

In step 710, the IM client 2 may save the data in the application number library into the call number identification database maintained by the operating system of the mobile phone 506.

In this embodiment, the storage process may first write the public number and its number description information in the push message to the application call number library, and then store the data in the application call number library to the call number identification database, so that the application call number library is included in the call number identification database. The data related to the “Enterprise IM” application can be synchronized with the data in the application call number library, so the IM client 2 can determine the data in the application call number library that is relevant to the call number identification database of the “Enterprise IM” application by reading the data stored in the application call number library without inquiring the operating system. In particular, the present disclosure can solve the issue when the operating system does not open the interrogation interface to IM client 2 for data security. Further, based on the foregoing processing manner, when the enterprise IM server receives the call request for the target object, the enterprise IM client 2 may initiate an inquiry to the IM client 2, so that the IM client 2 queries the application number library whether the public number and number description information associated with the enterprise that the initiator belongs exit. If it is determined that the public number and number description information associated with the enterprise that the initiator belongs exit, sending duplicate push messages may be avoided, thus avoiding unnecessary interaction process, and improving the response speed to the call request. In addition, the enterprise IM server can further maintain a cloud number library corresponding to the IM client 2, and the cloud number database is consistent with the application call number library maintained by the IM client 2, so that when receiving a call request from an initiator to the target object, the enterprise IM server can query the cloud number database to determine whether there is a public number and number description information of the enterprise to which the initiator belongs, which can further eliminate the interaction process between the enterprise IM server and the IM client 2, thus improving the response speed to the call request.

In other embodiments, the storage process may directly store the public number and its number description information in the push message to the call number identification database without maintaining the above-mentioned application call number library, thereby simplifying the processing and improving the processing efficiency. It may also help improve the response speed of the enterprise IM server to the call request.

In step 712, the IM client 2 may release the save process.

In this embodiment, the entire process of the push process for the push message can be silently executed in the background, so that the process of receiving and processing the push message is invisible to the target object and avoids interference and influence on the target object. And ensuring that the entire implementation process based on the technical solution of the present disclosure is almost the same as the conventional call process in the related art from the perspective of the user of the target object and avoids increasing the learning cost of the user.

In step 714, the IM client 2 may send a save success message to the enterprise IM server.

In this embodiment, by sending a storage success message to the enterprise IM server, the enterprise IM server can reduce the processing delay of the call request as much as possible while ensuring that the target device has completed processing the push message such that a long wait time for the initiator can be avoided.

In other embodiments, a waiting time may be pre-configured according to the processing duration that may be required when the IM client 2 processes the push message, so that the enterprise IM server starts recording time after issuing the push message, determines that the IM client 2 has completed processing the push message when the recorded time reaches the pre-configured wait time, and actively initiates the subsequent processing flow without waiting for the success message returned by the IM client 2 to reduce the interaction process.

In addition, the enterprise IM client 2 may not be able to successfully store the public number and its number description information in the call number identification database for various reasons, so the enterprise IM client 2 may store the public number and its number description information (only the public number and its number description information are stored, or the data of the application call number library is synchronized to the call number identification database) to the call number identification database if the operation counts for storing does not reach a preset number of times or the operation time does not reach a preset operation time. The storage IM client 2 can send a storage failure message to the enterprise IM server if it is not successfully stored until the preset number of times or the preset operation time is reached. In embodiments, the enterprise IM client 2 can also send a storage failure message to the enterprise IM server after the first failure. After receiving the storage failure message, the enterprise IM server may abandon the storage of the public number and its number description information and jump to the subsequent step 716.

The setting of the preset number of times or the preset operation time may prevent the enterprise IM client 2 from responding to the push message for a long time, causing the initiator to wait for a long time.

In step 716, the enterprise IM server may initiate a call to the initiator.

In step 718, after the initiator receives the call, the enterprise IM server may send a VoIP (Voice over Internet Protocol) push message to the operating system server corresponding to the mobile phone 506, and the VoIP push message is further pushed by the operating system server. That is, the enterprise IM server may initiate a VoIP call to the mobile phone 506.

In this embodiment, the enterprise IM server first initiates a call to the initiator, and after the initiator answers, initiates a call to the target object. In other embodiments, the enterprise IM server can also initiate a call to the initiator and the target object Meanwhile, and the present disclosure is not intended to be limiting. In other embodiments, the enterprise IM server may also initiate a call to the target object and return a response to the successful establishment of the call to the initiator after the target object answers, without having to call the initiator.

In this embodiment, the push process for the VoIP push message is similar to the push process of the push message described above. Specifically, the enterprise IM server adds the device key corresponding to the IM client 2 in the VoIP push message and sends it to the APNS, so that the APNS further pushes the VoIP push message to the IM Client 2 according to the device key included in the VoIP push message; wherein the VoIP push message is first pushed to the sending/receiving module (e.g., sending/receiving module 622 in FIG. 6) configured in the IM client 2, and if the IM client 2 registers the push request for the VoIP type push message at the sending/receiving module in advance, then after the sending/receiving module recognizes that the push message is a VoIP type, the sending/receiving module actively invokes the application function module (e.g., application function module 620 in FIG. 6) of the IM client 2 to timely respond and process the VoIP push message.

In step 720, the IM client 2 may issue a query to the operating system of the mobile phone 506.

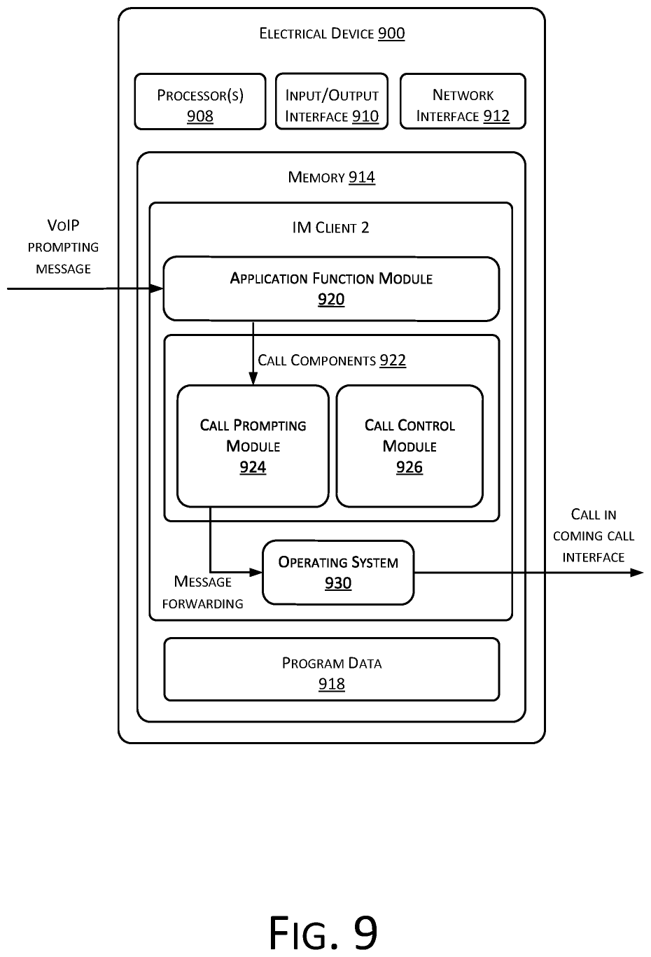

In this embodiment, the IM client 2 may be configured with an application function module (e.g., application function module 620 in FIG. 6) and an interfacing module (e.g., the interfacing module 624 in FIG. 6). When the mobile phone 506 adopts the iOS system, as shown in FIG. 9, the interface function module can be formed based on a Callkit framework. When the interfacing module is further configured with a prompting sub-module (e.g., the prompting sub-module 626 in FIG. 6) and a call control sub-module (e.g., the call control sub-module 628 in FIG. 6).

The prompting sub-module may correspond to The CXProvider (call notification) object and the call control sub-module under the Callkit framework may correspond to the CXCallController object under the Callkit framework. The CXProvider object is used to notify an operating system of an incoming event, such as an incoming call, an outgoing call connected, a call ended on remote side, etc., and the CXCallController object is used to enable the operating system to receive some messages such as requests from the application function module, start outgoing call, answer call, end call, etc.

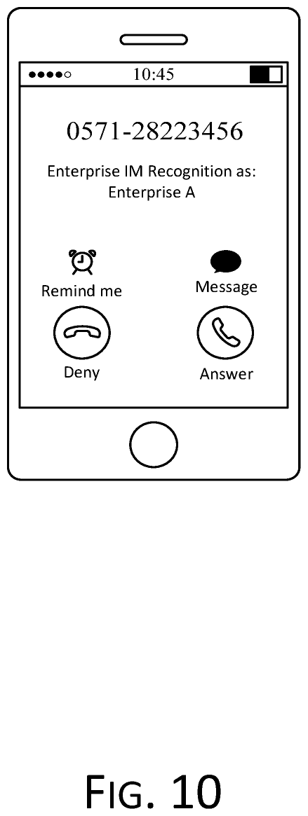

In this embodiment, when a VoIP notification (i.e., a VoIP push message) is detected, the CXProvider object may request its built-in native call interface from the operating system. For example, the CXProvider object may call the CXCallUpdate (information reporting) to implement interaction with the operating system. The CXProvider object can send a call request to the operating system through CXCallUpdate to invoke the built-in native call alert interface of the operating system. The call alert interface may be as shown in FIG. 10. The built-in incoming call interface in the operating system is only used in the related art for the incoming call alert of the traditional call based on the circuit switch domain. However, the present disclosure, the incoming call interface so that the network call has the same incoming call alert effect as the traditional call, thus, avoiding the network call being missed.

In step 722, the operating system may search the incoming call number in the incoming call number identification database.

In step 724, the operating system may display an incoming call interface for the VoIP call, and displays the call number description information corresponding to the incoming call number in the incoming call interface.

In this embodiment, the operating system further acquires the incoming call number based on the call request and matches the incoming call number with the data items stored in the call number identification database; wherein, when the incoming call number is the public number of the company A to which the initiator belongs, the operating system can determine the corresponding number description information based on the matched result and display it on the call alert interface. For example, as shown in FIG. 10, assuming that the public number is “0571-28223456” and the corresponding number description information is “Enterprise A,” “Enterprise IM Recognition as Enterprise A” may be displayed on the incoming call alert interface. The call number identification database maintained by the operating system may actually include a plurality of sub-databases corresponding to a plurality of third-party applications, so that each sub-database can be used to store the call number identification of the corresponding third-party application (i.e., the call number to be identified and its number description information). Then, when the operating system matches the call number description information “Enterprise A” corresponding to the public number “0571-28223456” in the sub-database corresponding to “Enterprise A”, “Enterprise IM Recognition as Enterprise A” is displayed, as shown in FIG. 10. Similarly, if the operating system matches the call number description information “Enterprise A” corresponding to the public number “0571-28223456” in the sub-database corresponding to “Enterprise Fetion,” “Enterprise IM Recognition as Fetion” may be displayed in the call alert interface.

It should be understood that in addition to the display of the call alert interface, the interfacing module can also call the built-in native ringtone of the operating system, so that the network call has the same call alert effect as the traditional call through various aspects such as viewing and hearing.

In step 726, the IM client 2 may determine that the VoIP call is answered by the target object.

In step 728, the IM client 2 may establish a network call with the enterprise IM server.

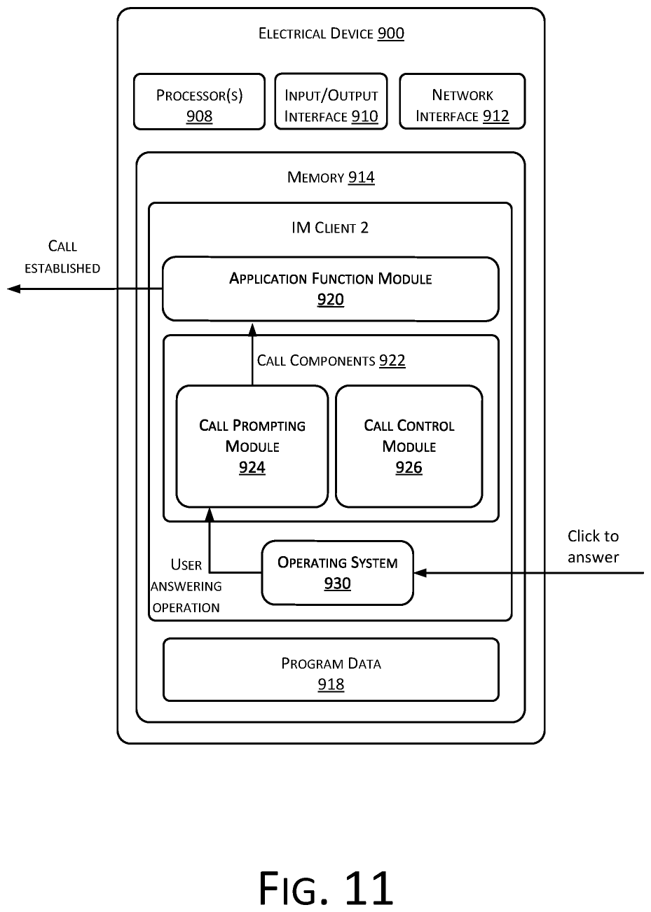

In this embodiment, when the operating system needs the CXProvider object to know the operation performed by the user, the information can be transmitted through CXAction (user operation). As shown in FIG. 11, when the user performs an answering operation on the incoming call alert interface shown in FIG. 10, the operating system can monitor the receiving operation and correspond to the answering operation through CXAnswerCallAction (a user answering operation and one of CXAction). After the CXProvider object is notified to the application function module, the application function module only needs to perform the audio and video call logic during the original network call, and the corresponding network call can be established and implemented.

In embodiments, the technical solution of the present disclosure is applicable to a call process implemented by a PSTN (Public Switched Telephone Network) network. Then, the above steps 716-728 can be replaced with the following operations described herein.

It is assumed that the user AA initiates a call request through the mobile phone 504 in step 702, and it is desirable that the enterprise IM server initiates a call to the user BB based on the public number P1 of the enterprise A to which the user AA belongs. Then, the enterprise IM server can issue a call request to the PSTN network for the public number P1, so that the PSTN network performs a call operation based on the public number P1 to the mobile phone number P2 of the mobile phone 506 used by the user BB.

When the mobile phone 506 receives the call request initiated by the PSTN, the mobile phone 506 can extract the caller number P1 and identify it in the caller number identification library. Since the above-mentioned steps 702-714 or other embodiments of the present disclosure, the caller number identification library in the mobile phone 506 already stores the name information of the public number P1 and the enterprise A (that is, the call number description information corresponding to the public number P1), the mobile phone 506 can recognize that the electric number P1 corresponds to the name information of the enterprise A, thereby displaying the name information of the enterprise A in the incoming call page, such as “enterprise A” shown in FIG. 10.

Meanwhile, the PSTN network can also initiate a call to the mobile phone 504 used by the user AA. After the user AA and the user BB respectively answer the call, the PSTN can establish a call between the two users.

In summary, the present disclosure sends the call number and the corresponding number description information used by the initiator to the target object by pushing the message before the call is established, so that the target object extracts relevant data from the push message and performs match operations on the call number identification library maintained by the system. it is not necessary to store a large number of numbers (and corresponding number description information) into the call number identification library in advance, and the operating system does not need to open the operation of obtaining the call number to the third-party application. After the call is established, the operating system of the target object can match, identify, and display the corresponding number description information based on the call number identification library to achieve effect alert to the target object.

FIG. 9 illustrates an example schematic diagram of functional modules of an electronic device for call prompting according to an embodiment of the present disclosure.

Any of the mobile phones 504-508 in FIG. 5 may be implemented on an electronic device 600 as shown in FIG. 9. The electronic device 900 may include a IM Client 2 and an operating system 930. The IM Client 2 may further include an application function module 920 and call components 922. The call components 922 may include a call prompting module 924 and a call control module 926.

In embodiments, the electronic device 900 may include processor(s) 908, an input/output interface 910, a network interface 912, and a memory 914.

The memory 914 may include a form of computer readable media such as a volatile memory, a random-access memory (RAM) and/or a non-volatile memory, for example, a read-only memory (ROM) or a flash RAM. The memory 914 is an example of a computer readable media.

In embodiments, the memory 914 may include program modules of the IM Client 2 and program data 918. The program modules the IM Client 2 may include the application function module 920 and the call components 922 including the call prompting module 924 and the call control module 926.

As illustrated in FIG. 9, when a VoIP prompting message is received at the application function module 920 of IM Client 2, the VoIP prompting message may be forwarded to the call prompting module 924 and further forwarded to the operating system 930 to call an incoming call interface to display the call number and the call number description.

FIG. 11 illustrates an example schematic diagram of functional modules of an electronic device for call answering according to an embodiment of the present disclosure.

FIG. 11 includes elements similar to those described in FIG. 9. Thus, those function modules are not detailed herein.

As illustrated in FIG. 11, when the user of IM Client 2 clicks on the incoming call interface to answer the call, the user answering operation may be received by the operating system 930 and forwarded to the call prompting module 924 of the call components 922. The user answering operation may be further forwarded to the application function module 920 to be transmitted to the IM server to establish the call.

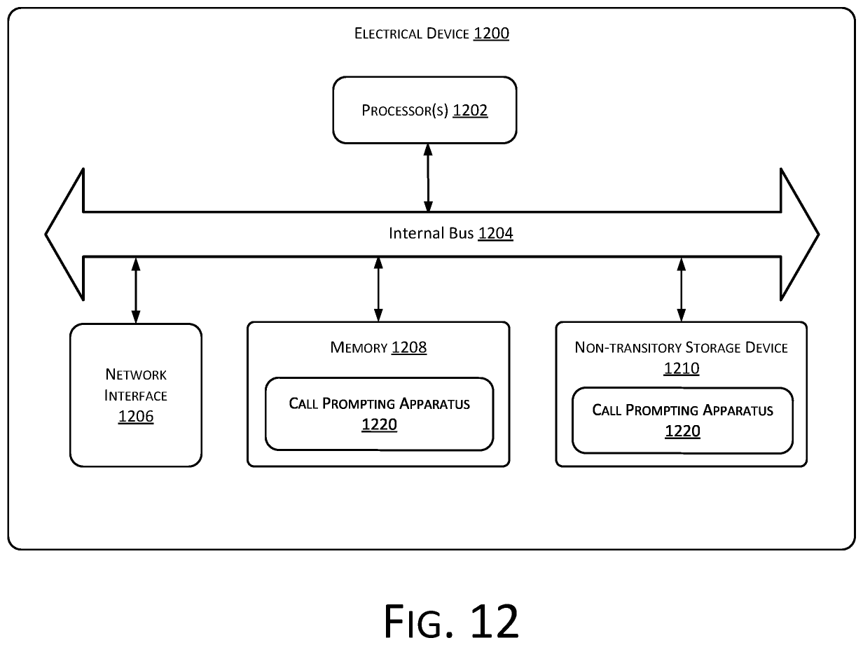

FIG. 12 illustrates an example schematic diagram of an electronic device on a server side according to an embodiment of the present disclosure.

Referring to FIG. 12, at the hardware level, the electronic device 1200 includes processor(s) 1202, an internal bus 1204, a network interface 1206, a memory 1208, and a non-volatile memory 1210, and hardware required for other services. The processor(s) 1202 reads the corresponding computer program from the non-volatile memory 1210 into the memory 1208 and then operates to form a call prompting device on a logical level.

In embodiments, a call prompting apparatus 1220 may be implemented on the memory 1208 of the electronic device 1200. In embodiments, in addition to the software implementation, the present disclosure does not exclude other implementation manners, such as a logic device or a combination of software and hardware, etc., that is, the execution body of the following processing flow is not limited to each logical unit and may be hardware or logic device.

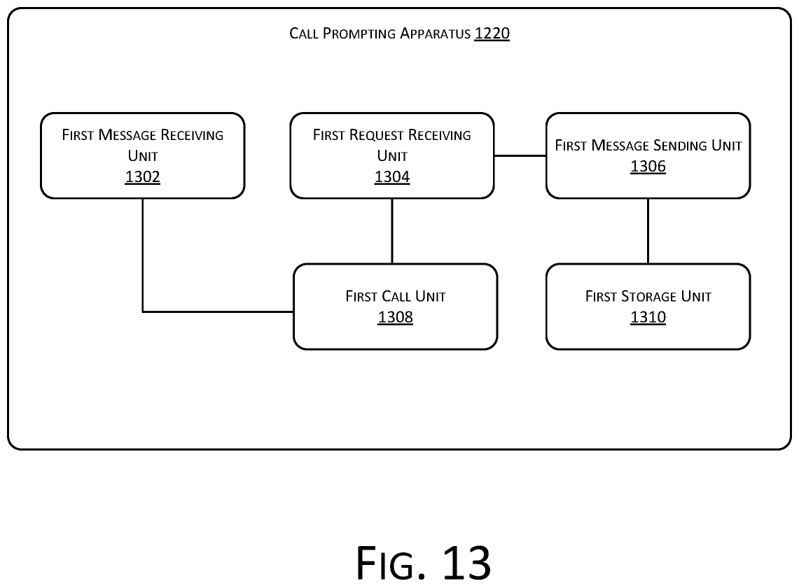

FIG. 13 illustrates an example block diagram of a server-side call prompting apparatus according to an embodiment of the present disclosure.

Referring to FIG. 13, in the software implementation, the call prompting apparatus 1220 as illustrated in FIG. 12 may include a first request receiving unit 1304 causes the server to receive a call request from the initiator, where the call request is initiated based on the call number corresponding to the initiator; a first message sending unit 1306 configured to send, by the server, a push message to a target object of the call request, where the push message includes the call number and corresponding call number description information, so that the target object displays the call number description information in the corresponding incoming call interface when the call request is received.

In embodiments, the first message sending unit 1306 is specifically configured to cause the server to send a push message to an operating system server corresponding to the target operating system of the target object, to push the push message to the target object by the operating system server.

In embodiments, the call prompting apparatus 1220 may further include a first storage unit 1310, causing the server to determine whether the target object stores the call number and the call number description information; when it is determined that the call number and the call number description information is not stored, the push message includes the call number and corresponding number description information.

In embodiments, the first message sending unit 1306 may cause the server to determine whether the target object stores the call number and the call number description information by causing the server to determine whether the target object stores the call number and corresponding description information; wherein, when the call number and the corresponding description information are present, the server determines that the target object stores the call number And the call number description information; or, when the server determines that the target object stores the call number and the corresponding description information, the server further determines whether the corresponding description information is the latest information; wherein, when the server determines that the corresponding description information is the latest information, the server determines that the target object stores the call number and the call number description information.

In embodiments, the first message sending unit 1306 may cause the server to determine whether the target object stores the call number and the call number description information by causing the server to query historical data to determine whether the target object stores the call number and the call number description information.

In embodiments, the first message sending unit 1306 may cause the server to determine whether the target object stores the call number and the call number description information by causing the server to send an inquiry message to the target object to determine whether the call number and the call number description information are stored by the target object.

In embodiments, the first message sending unit 1306 may cause the server to query historical data to determine whether the target object stores the call number and the call number description information by performing the operations described herein.

When the historical data includes a push message record, the first message sending unit 1306 may cause the server to determine whether to send the push message to the target object according to the push message record; wherein, when the call number is sent to the target object when the related push message is sent, or the push message containing the call number and the call number description information is sent to the target object, the server may determine that the target object stores the call number and the call number description information.

In embodiments, the first message sending unit 1306 may be configured to cause the server to generate the push message according to the pre-stored number description information and send the push message to the target object when the server pre-stores the call number description information corresponding to the call number.

When the server does not pre-store the call number description information corresponding to the call number, the server may be caused to generate the push message according to the call number description information sent by the initiator and send the push message to the target object.

In embodiments, when the call number is the personal number of the initiator, the call number description information may be personal description information of the initiator.

When the call number is a public number of the group to which the initiator belongs, the call number description information may be group description information of the group to which the initiator belongs.

In embodiments, the target object operating system has a permission restriction on the installed third-party application, so that the third-party application cannot perform call number identification on the call request received by the target object and display the recognition result in the incoming call interface.

In embodiments, the push message may be used to instruct the target object to store the call number and the call number description information to a call number identification information library of the target object, so that the target object obtains the corresponding number description information from the call number identification information library when a call request based on the call number is received, and displays the call number description information in the corresponding incoming call interface.

In embodiments, the call number identification information library may be provided by the target object operating system.

In embodiments, the call prompting apparatus 1220 may further include a first message receiving unit 1302 configured to enable the server to receive a storage success message returned by the target object, indicating that the target object has stored the call number and the call number description information to the caller number identification information database; a first call unit 1308 configured to cause the server to perform a call operation based on the call number to the communication numbers of the initiator and the target through a communication network.

In embodiments, the server may include a server of an instant messaging application.

In embodiments, the call number may be pre-configured to correspond to the initiator.

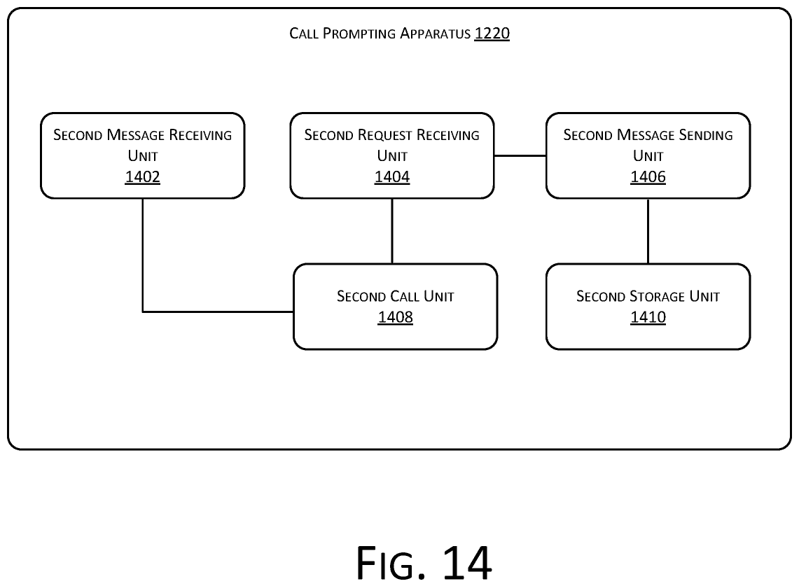

FIG. 14 illustrates an example block diagram of a server-side call prompting apparatus according to another embodiment of the present disclosure.

Referring to FIG. 14, in the software implementation, the call prompting apparatus 1220 as illustrated in FIG. 12 may include a second request receiving unit 1404 configured to cause the server to receive a call request from the initiator; a second message sending unit 1406, configured to send, by the server, a push message to a target object of the call request, where the push message includes a pre-configured call number associated with the initiator and corresponding call number description information, so that the target object displays the call number description information in a corresponding incoming call page when receiving a call request based on the pre-configured number.

In embodiments, the second message sending unit 1406 may be configured to cause the server to send a push message to an operating system server corresponding to the target operating system of the target, to push the push message to the target by the operating system server.

In embodiments, the call prompting apparatus 1220 may further include a second storage unit 1410 configured to enable the server to determine whether the target object stores the pre-configured number and the call number description information.

The second message sending unit 1406 may send the pre-configured number and the corresponding number description information to the target object when it is determined that the call number and the call number description are not stored.

In embodiments, the second message sending unit 1406 may be configured to cause the server to determine whether the target object stores the pre-configured number and the call number description information. When the pre-configured number and corresponding description information are present, the server determines the target storage having the pre-configured number and the call number description information. When the server determines that the target object stores the pre-configured number and the corresponding description information, the server further determines whether the corresponding description information is the latest information; wherein, when the corresponding description information is determined to be the latest information, the server determines that the target object stores the pre-configured number and the call number description information.

In embodiments, the second message sending unit 1406 may be configured to determine, by the server, whether the target object stores the pre-configured number and the call number description information by causing the server to query historical data to determine whether the target object stores the pre-configured number and the call number description information.

In embodiments, the second message sending unit 1406 may cause the server to send an inquiry message to the target object to determine whether the pre-configured number and the call number description information are stored by the target object.

In embodiments, the second message sending unit 1406 may cause the server to query historical data to determine whether the target object stores the pre-configured number and the call number description information by performing the operations described herein.

When the historical data includes a data transmission record, the second message sending unit 1406 may cause the server to determine whether to send the pre-configured number and the call number description information to the target object according to the data transmission record. When the pre-configured number and the call number description information has been sent to the target object, it is determined that the target object stores the pre-configured number and the call number description information.

In embodiments, the second message sending unit 1406 may be configured to send the pre-stored number description information to the target object when the server pre-stores the call number description information corresponding to the pre-configured number.

When the server does not pre-store the call number description information corresponding to the pre-configured number, the server may be configured to obtain the call number description information sent by the initiator and send the call number description information to the target object.

In embodiments, when the call number is the personal number of the initiator, the call number description information may be personal description information of the initiator.

When the call number is a public number of the group to which the initiator belongs, the call number description information may be group description information of the group to which the initiator belongs.

In embodiments, the target object operating system has a permission restriction on the installed third-party application, so that the third-party application cannot perform call number identification on the call request received by the target object and display the recognition result in the incoming call interface.

In embodiments, the push message may be used to instruct the target object to store the call number and the call number description information to a call number identification information library of the target object, so that the target object obtains the corresponding number description information from the call number identification information library when a call request based on the call number is received, and displays the call number description information in the corresponding incoming call interface.

In embodiments, the call number identification information library may be provided by the target object operating system.

In embodiments, the call prompting apparatus 1220 may further include a second message receiving unit 1402 configured to enable the server to receive the storage success message returned by the target object, indicating that the target object has stored the pre-configured number and the call number description information to the call number identification information library; and a second call unit 1408 configured to enable the server to perform a call operation based on the pre-configured number to the communication numbers of the initiator and the target object by using a communication network.

In embodiments, the server may include a server of an instant messaging application.

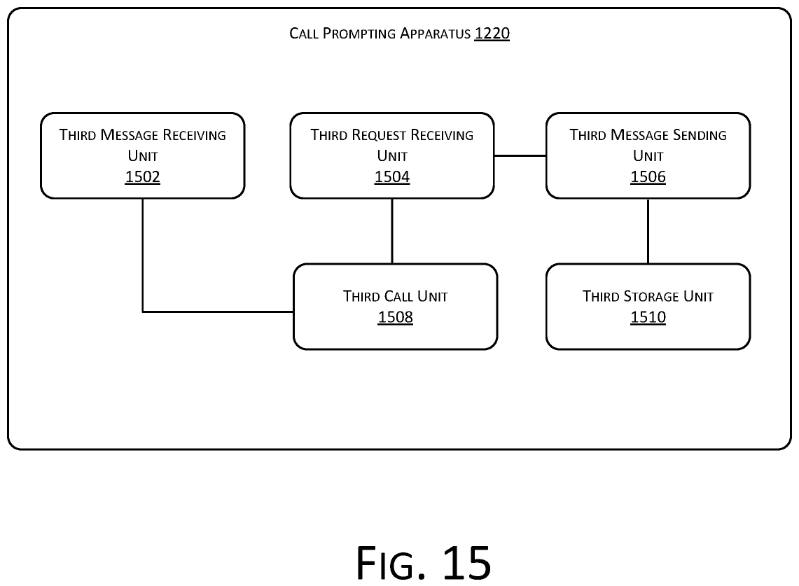

FIG. 15 illustrates an example block diagram of a server-side call prompting apparatus according to another embodiment of the present disclosure.

Referring to FIG. 15, in the software implementation, the call prompting apparatus 1220 as illustrated in FIG. 12 may include a third request receiving unit 1504 configured to cause the server to receive a call request from the initiator, where the call request is initiated based on the call number corresponding to the initiator; a third message sending unit 1506 configured to send the call number and the corresponding number description information to the target object of the call request, so that the target object receives the call request based on the call number and display the call number description information in the corresponding incoming call interface.

In embodiments, the third message sending unit 1506 may be configured to cause the server to send a push message to an operating system server corresponding to the target object operating system of the target object, to push the push message to the target object by the operating system server.

In embodiments, the call prompting apparatus 1220 may further include a third storage unit 1510 configured to determine, by the server, whether the target object stores the call number and the call number description information.

When it is determined that the call number and the call number description information are not stored, the third message sending unit 1506 may transmit the call number and the corresponding number description information to the target object.

In embodiments, the third message sending unit 1506 may cause the server to determine whether the target object stores the call number and the call number description information by causing the server to determine whether the target object stores the call number and corresponding description information; wherein, when the call number and the corresponding description information are present, the server determines that the target object stores the call number And the call number description information; or, when the server determines that the target object stores the call number and the corresponding description information, the server further determines whether the corresponding call number description information is the latest information; wherein, when it is determined that the corresponding call number description information is the latest information, the server determines that the target object stores the call number and the call number description information.

In embodiments, the third message sending unit 1506 may cause the server to determine whether the target object stores the call number and the call number description information by causing the server to query historical data to determine whether the target object stores the call number and the call number description information.

In embodiments, the third message sending unit 1506 may cause the server to send an inquiry message to the target object to determine whether the call number and the call number description information are stored by the target object.

In embodiments, the third message sending unit 1506 may cause the server to query historical data to determine whether the target object stores the call number and the call number description information by performing the operations described herein.

When the historical data includes a data transmission record, the third message sending unit 1506 may cause the server to determine whether to send the call number and the call number description information to the target object according to the data transmission record; wherein, when the call number and the call number description information has been sent to the target object, it is determined that the target object stores the call number and the call number description information.

In embodiments, the third message sending unit 1506 may be configured to send the pre-stored number description information to the target object when the server pre-stores the call number description information corresponding to the call number.

Further, when the server does not pre-store the call number description information corresponding to the call number, the server may be configured to obtain the call number description information sent by the initiator and send the call number description information to the target object

In embodiments, when the call number is the personal number of the initiator, the call number description information may be personal description information of the initiator.

When the call number is a public number of the group to which the initiator belongs, the call number description information may be group description information of the group to which the initiator belongs.

In embodiments, the target object operating system has a permission restriction on the installed third-party application, so that the third-party application cannot perform call number identification on the call request received by the target object and display the recognition result in the incoming call interface.

In embodiments, the push message may be used to instruct the target object to store the call number and the call number description information to a call number identification information library of the target object, so that the target object obtains the corresponding number description information from the call number identification information library when a call request based on the call number is received, and displays the call number description information in the corresponding incoming call interface.

In embodiments, the call number identification information library may be provided by the target object operating system.

In embodiments, the call prompting apparatus 1220 may include a third message receiving unit 1502 causing the server to receive the storage success message returned by the target object, indicating that the target object has stored the call number and the call number description information to the caller number identification information database; and a third call unit 1508 causing the server to perform a call operation based on the call number to the communication numbers of the initiator and the target object by using a communication network.

In embodiments, the server may include a server of an instant messaging application.

In embodiments, the call number may be pre-configured to correspond to the initiator.

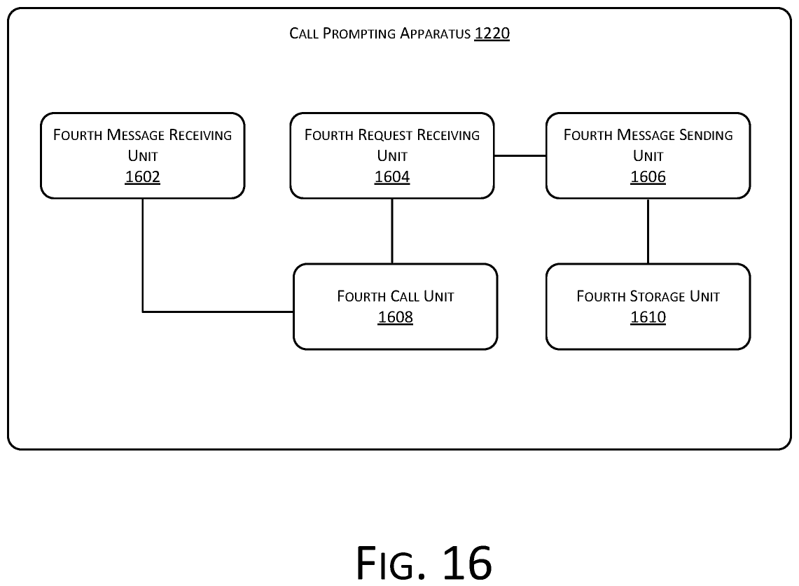

FIG. 16 illustrates an example block diagram of a server-side call prompting apparatus according to another embodiment of the present disclosure.

Referring to FIG. 16, in the software implementation, the call prompting apparatus 1220 as illustrated in FIG. 12 may include a fourth request receiving unit 1604 causing the server to receive a call request from the initiator, where the call request is initiated based on the call number corresponding to the initiator; and a fourth message sending unit 1606, configured to send, by the server, a call request based on the call number and a prompt message including number description information to a target of the call request, so that the target object displays the call number description information in the incoming call interface.

In embodiments, the fourth message sending unit 1606 may be configured to cause the server to send a prompt message to an operating system server corresponding to the target operating system of the target object, so that the prompt message is pushed by the operating system server to the target object.

In embodiments, the call prompting apparatus 1220 may further include a fourth storage unit 1610 configured to enable the server to determine whether the target object stores the call number and the call number description information; and the prompt message may include the call number description information corresponding to the call number when it is determined that the call number and the call number description information are not stored.

In embodiments, the fourth message sending unit 1606 may be configured to enable the server to determine whether the target object stores the call number and the call number description information by causing the server to determine whether the target object stores the call number and corresponding description information. When the call number and the corresponding description information are present, the server may determine that the target object stores the call number and the call number description information.

In embodiments, when the server determines that the target object stores the call number and the corresponding call number description information, the server may further determine whether the corresponding call number description information is the latest information. When it is determined that the call number corresponding description information is the latest information, the server may determine that the target object stores the call number and the call number description information.

In embodiments, the fourth message sending unit 1606 may be configured to enable the server to determine whether the target object stores the call number and the call number description information by causing the server to query historical data to determine whether the target object stores the call number and the call number description information.

In embodiments, the fourth message sending unit 1606 may be configured to enable the server to determine whether the target object stores the call number and the call number description information by causing the server to send an inquiry message to the target object to determine whether the call number and the call number description information are stored by the target object.

In embodiments, the fourth message sending unit 1606 may cause the server to query historical data to determine whether the target object stores the call number and the call number description information by perform the operations described herein.

When the historical data includes a message transmission record, the fourth message sending unit 1606 may cause the server to determine, according to the message transmission record, whether a prompt message related to the call number is sent to the target object. When the prompt message related to the call number has been sent to the target object, the server may determine that the target object stores the call number and the call number description information.

In embodiments, the fourth message sending unit 1606 may be configured to cause the server to generate a prompt message according to the call number description information pre-stored by the server and send the prompt message to the target object when the server pre-stores the call number description information corresponding to the call number.

When the server does not pre-store the call number description information corresponding to the call number, the fourth message sending unit 1606 may be configured to cause the server to generate a prompt message according to the call number description information sent by the initiator to the server and send the prompt message to the target object.

In embodiments, when the call number is the personal number of the initiator, the call number description information may be personal description information of the initiator.

When the call number is a public number of the group to which the initiator belongs, the call number description information may be group description information of the group to which the initiator belongs.

In embodiments, the target object operating system has a permission restriction on the installed third-party application, so that the third-party application cannot perform call number identification on the call request received by the target object and display the recognition result in the incoming call interface.

In embodiments, the push message may be used to instruct the target object to store the call number and the call number description information to a call number identification information library of the target object, so that the target object obtains the corresponding number description information from the call number identification information library when a call request based on the call number is received, and displays the call number description information in the corresponding incoming call interface.

In embodiments, the call number identification information library may be provided by the target object operating system.

In embodiments, the call prompting apparatus may further include a fourth message receiving unit 1602 configured to enable the server to receive the storage success message returned by the target object, indicating that the target object has stored the call number and the call number description information to the caller number identification information database; and a fourth call unit 1608 is configured to enable the server to perform a call operation based on the call number to the communication numbers of the initiator and the target by using a communication network.

In embodiments, the server may include a server of an instant messaging application.

In embodiments, the call number may be pre-configured to correspond to the initiator.

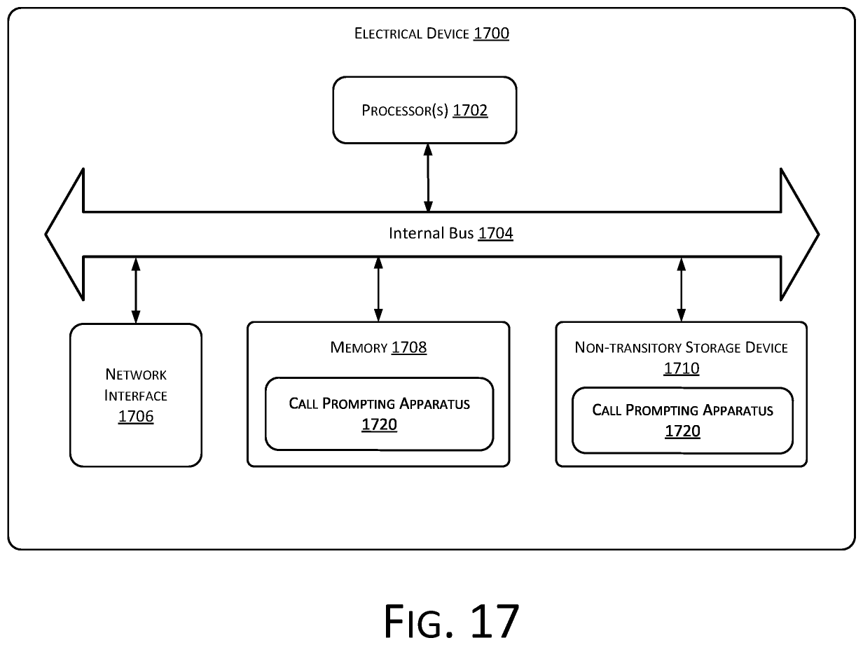

FIG. 17 illustrates an example schematic diagram of an electronic device on a client side according to an embodiment of the present disclosure.

Referring to FIG. 17, at the hardware level, the electronic device 1700 includes processor(s) 1702, an internal bus 1704, a network interface 1706, a memory 1708, and a non-volatile memory 1710, and hardware required for other services. The processor(s) 1702 reads the corresponding computer program from the non-volatile memory 1710 into the memory 1708 and then operates to form a call prompting device on a logical level.

In embodiments, a call prompting apparatus 1720 may be implemented on the memory 1708 of the electronic device 1700. In embodiments, in addition to the software implementation, the present disclosure does not exclude other implementation manners, such as a logic device or a combination of software and hardware, etc., that is, the execution body of the following processing flow is not limited to each logical unit and may be hardware or logic device.

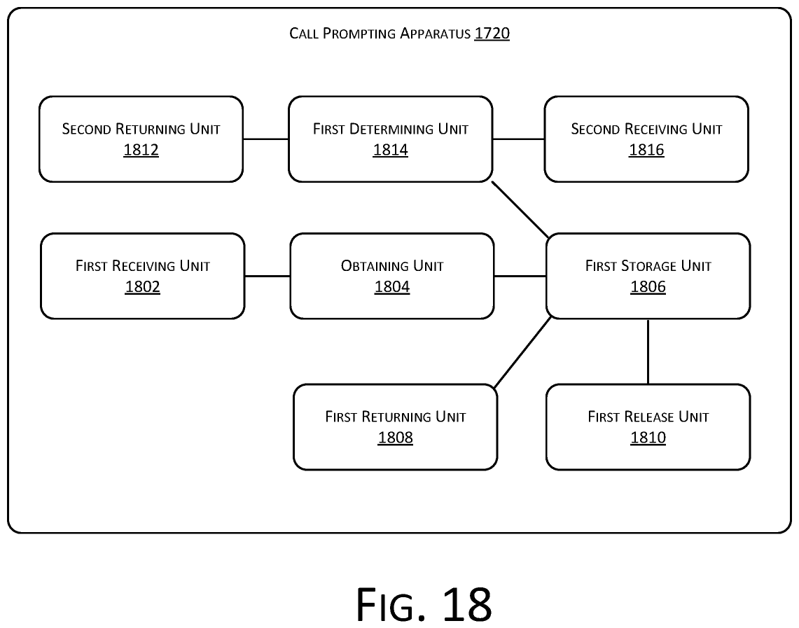

FIG. 18 illustrates an example block diagram of a client-side call prompting apparatus according to an embodiment of the present disclosure.

Referring to FIG. 18, in the software implementation, the call prompting apparatus 1720 as illustrated in FIG. 17 may include a first receiving unit 1802 configured to cause the target object to receive a push message, where the push message is generated by the server according to the received call request from the initiator, and the call request is initiated based on the call number corresponding to the initiator.

The call prompting apparatus 1720 may further include an obtaining unit 1804 configured to enable the target object to obtain the call number and corresponding number description information included in the push message to display the call number description information in an incoming call page corresponding to the call number.

In embodiments, the first receiving unit 1802 may be configured to cause the target object to receive the push message pushed by an operating system server corresponding to the operating system of the target object, where the push message is generated by the server and sent to the operating system server.

In embodiments, the first receiving unit 1802 may be configured to cause the target object to receive the push message pushed by the operating system server by using a sending/receiving module configured in the target object and matched to the operating system of the device.

In embodiments, the sending/receiving module may pre-register the receiving requirement for the push message at the operating system of the target object.

In embodiments, when the call number is the personal number of the initiator, the call number description information is personal description information of the initiator.

In embodiments, when the call number is a public number of the group to which the initiator belongs, the call number description information is group description information of the group to which the initiator belongs.

In embodiments, the call prompting apparatus 1720 may further include a first storage unit 1806 configured to cause the target object to store the call number and the call number description information to the call number identification information library of the target object, so that when there is a call request based on the call number, the caller number identification information library is used to acquire the call number description information corresponding to the call number, and the acquired call umber description information is presented to the target object on an incoming call interface.

In embodiments, the first storage unit 1806 may be configured to cause the target object to keep silently running in the background of the device operating system during the storage process or the storage thread to store the call number and the call number description information to the call number identification information library.

In embodiments, the storage process or the storage thread is invoked by the target object to store the call number and the call number description information to the call number identification information library.

In embodiments, the call prompting apparatus 1720 may further include a first release unit 1810 causing the target object to release the storage process or the storage thread after storing the call number and the call number description information to the call number identification information library.

In embodiments, the call prompting apparatus 1720 may further include a first returning unit 1808, after storing the call number and the call number description information to the call number identification information library, causing the target object to return a storage success message to the server to enable the server performing a call operation based on the call number to the communication number of the initiator and the target object through a communication network.

In embodiments, the call prompting apparatus 1720 may further include a second receiving unit 1816 configured to enable the target object to receive an inquiry message sent by the server.

In embodiments, the call prompting apparatus 1720 may further include a first determining unit 1814 configured to enable the target object to determine, according to the query message, whether the target object stores the call number and the call number description information;

In embodiments, the call prompting apparatus 1720 may further include a second returning unit 1812 causing the target object to return an inquiry result to the server, so that the server sends the inquiry result indicating the call number and the call number description information are not stored. The target object may send the push message including the call number and the call number description.

In embodiments, the first determining unit 1814 may be configured to cause the target object to determine whether the target object stores the call number and corresponding call number description information when the call number of the inquiry message is included. When the call number and corresponding call number description information are present, the target object may determine that the target object stores the call number and the call number description information

In embodiments, when the inquiry message includes the call number and the call number description information, the first determining unit 1814 may be configured to cause the target object to determine whether the target object stores the call number and corresponding call number description information, and whether the corresponding call number description information related to the call number is consistent with the stored corresponding call number description information. When the call number and the corresponding call number description information are present, and the corresponding call number description information is consistent with the stored corresponding call number description information, the target object may determine that the target object stores the call number and the call number describes the information.

In embodiments, the target object may include a client of an instant messaging application; and the server may include a server of the instant messaging application.

In embodiments, the call number may be pre-configured to correspond to the initiator.

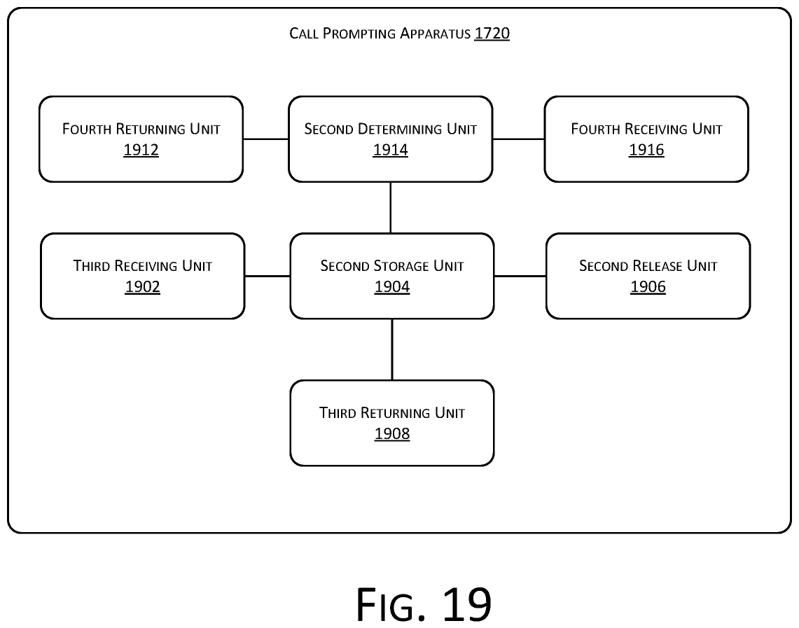

FIG. 19 illustrates an example block diagram of a client-side call prompting apparatus according to another embodiment of the present disclosure.

Referring to FIG. 19, in the software implementation, the call prompting apparatus 1720 as illustrated in FIG. 17 may include a third receiving unit 1902 configured to cause the target object to receive the call number sent by the server and the corresponding number description information, and when the server receives the call request initiated by the initiator based on the call number, the call number and the call number description The information is sent by the server to the target object, so that the target object displays the call number description information in an incoming call interface corresponding to the call number.

In embodiments, the third receiving unit 1902 may be configured to cause the target object to receive the call number and the call number description information pushed by an operating system server corresponding to the operating system of the device, where the call number and the call number description information are sent by the server to the operating system Server.

In embodiments, the third receiving unit 1902 may be configured to cause the target object to receive the call number and the call number description information pushed by the operating system server by using a push receiving module configured in the target object and matched to the operating system of the device.

In embodiments, the push receiving module may pre-register the acquisition requirement of the pushed number and number description information at the device operating system.

In embodiments, when the call number is the personal number of the initiator, the call number description information is personal description information of the initiator.

When the call number is a public number of the group to which the initiator belongs, the call number description information is group description information of the group to which the initiator belongs.

In embodiments, the call prompting apparatus 1720 may further include a second storage unit 1904 configured to cause the target object to store the call number and the call number description information to the call number identification information library of the target object, so that when there is a call request based on the call number, the caller number identification information library is used to acquire call number description information corresponding to the call number, and the acquired call number description information is presented to the target object on an incoming call interface.

In embodiments, the second storage unit 1904 may be configured to cause the target object to keep silently running in the background of the device operating system during the storage process or the storage thread to store the call number and the call number description information to the call number identification information library.

In embodiments, the storage process or the storage thread may be invoked by the target object to store the call number and the call number description information to the call number identification information library.

In embodiments, the call prompting apparatus 1702 may further include a second release unit 1906 configured to enable the target object to release the storage process or the storage thread after storing the call number and the call number description information to the call number identification information library.

In embodiments, the call prompting apparatus 1702 may further include a third returning unit 1908, after storing the call number and the call number description information to the call number identification information library, causing the target object to return a storage success message to the server to enable the service to perform a call operation based on the call number to the communication number of the initiator and the target through a communication network.

In embodiments, the call prompting apparatus 1702 may further include a fourth receiving unit 1916 configured to enable the target object to receive an inquiry message sent by the server.

In embodiments, the call prompting apparatus 1702 may further include a second determining unit 1914 configured to enable the target object to determine, according to the query message, whether the target object stores the call number and the call number description information.

In embodiments, the call prompting apparatus 1702 may further include a fourth returning unit 1912 causing the target object to return an inquiry result to the server, so that the server sends the inquiry result indicating that the call number and the call number description information are not stored. The target object may send the push message including the call number and the call number description information.

In embodiments, the second determining unit 1914 may be configured to cause the target object to determine whether the target object stores the call number and corresponding description information when the call number of the inquiry message is included. When the call number and corresponding call number description information are present, the target object may determine that the target object stores the call number and the call number description information.

In embodiments, when the inquiry message includes the call number and the call number description information, the second determining unit 1914 may be configured to cause the target object to determine whether the target object stores the call number and corresponding call number description information, and whether the corresponding call number description information related to the call number description information is consistent with the stored corresponding call number description information; wherein, when the call number and the corresponding call number description information are present, and the corresponding call number description information is consistent with the stored call number description information, the target object may determine that the target object stores the call number and the call number describes the information.

In embodiments, the target object may include a client of an instant messaging application; and the server may include a server of the instant messaging application.

In embodiments, the call number may be pre-configured to correspond to the initiator.

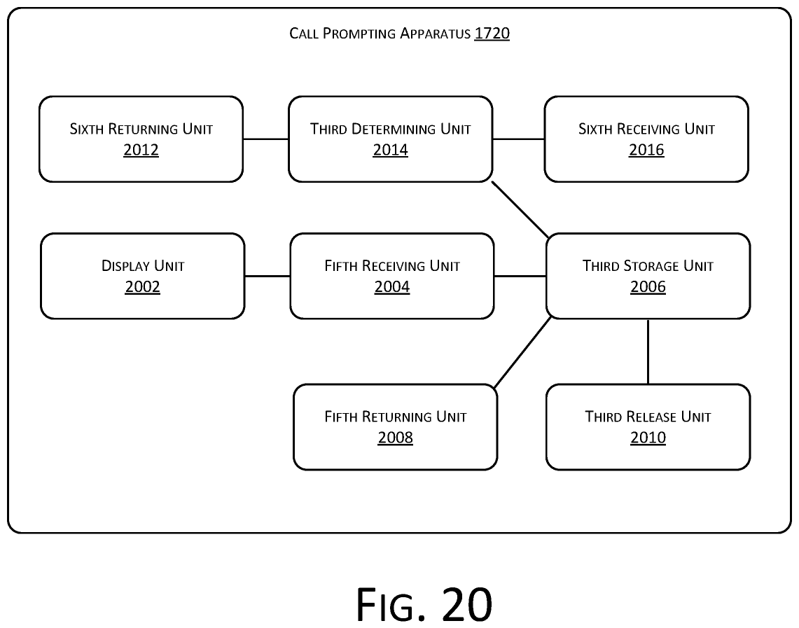

FIG. 20 illustrates an example block diagram of a client-side call prompting apparatus according to another embodiment of the present disclosure.

Referring to FIG. 20, in the software implementation, the call prompting apparatus 1720 as illustrated in FIG. 17 may include a fifth receiving unit 2004 configured to enable the target object to receive the call request and the prompt message sent by the server. When the server receives the call request initiated by the initiator according to the call number, the call request is determined by the server based on the call number sent to the target object, and the prompt message includes the call number description information corresponding to the call number.

In embodiments, the call prompting apparatus 1720 may further include a display unit 2002 causing the target object to display the call number description information in an incoming call interface corresponding to the call request.

In embodiments, the fifth receiving unit 2004 may be configured to cause the target object to receive the prompt message that is sent by an operating system server corresponding to the operating system of the device, where the prompt message is generated by the server and sent to the operating system server.

In embodiments, the fifth receiving unit 2004 may be configured to cause the target object to receive the prompt message pushed by the operating system server by using a sending/receiving module configured in the target object and matched to the operating system of the device.

In embodiments, the sending/receiving module may pre-register the acquisition requirement of the prompt message at the device operating system.

In embodiments, when the call number is the personal number of the initiator, the call number description information is personal description information of the initiator.

When the call number is a public number of the group to which the initiator belongs, the call number description information is group description information of the group to which the initiator belongs.

In embodiments, the call prompting apparatus 1702 may further include a third storage unit 2006 causing the target object to store the call number and the call number description information to the call number identification information library of the target object, so that when there is a call request based on the call number, the call number identification information library is used to acquire number description information corresponding to the call number, and the acquired number description information is presented to the target object on an incoming call interface.

In embodiments, the third storage unit 2006 may be further configured to cause the target object to keep silently running in the background of the device operating system during the storage process or the storage thread to store the call number and the call number description information to the call number identification information library.

In embodiments, the storage process or the storage thread may be invoked by the target object to store the call number and the call number description information to the call number identification information library.

In embodiments, the call prompting apparatus 1702 may further include a third release unit 2010 causing the target object to release the storage process or the storage thread after storing the call number and the call number description information to the call number identification information library.

In embodiments, the call prompting apparatus 1702 may further include a fifth returning unit 2008, after storing the call number and the call number description information to the caller number identification information database, causing the target object to return a storage success message to the server to enable the service to perform a call operation based on the call number to the communication number of the initiator and the target through a communication network.

In embodiments, the call prompting apparatus 1702 may further include a sixth receiving unit 2016 configured to enable the target object to receive an inquiry message sent by the server.

In embodiments, the call prompting apparatus 1702 may further include a third determining unit 2014 configured to enable the target object to determine, according to the query message, whether the target object stores the call number and the call number description information.

In embodiments, the call prompting apparatus 1702 may further include a sixth returning unit 2012 causing the target object to return an inquiry result to the server, so that the server sends the inquiry result indicating that the call number and the call number description information are not stored. The target object may send the prompt message including the call number and the call number description.

In embodiments, the third determining unit 2014 may be configured to cause the target object to determine whether the target object stores the call number and corresponding call number description information when the call number of the inquiry message is included. When the call number and call number corresponding description information are present, the target object may determine that the target object stores the call number and the call number description information.

In embodiments, when the inquiry message includes the call number and the call number description information, the third determining unit 2014 may be configured to cause the target object to determine whether the target object stores the call number and corresponding call number description information, and whether the corresponding call number description information related to the call number description information is consistent with the stored call number description information; wherein, when the call number and the corresponding call number description information are present, and the corresponding call number description information is consistent with the stored call number description information, the target object may determine that the target object stores the call number and the call number describes the information.

In embodiments, the target object may include a client of an instant messaging application; and the server may include a server of the instant messaging application.

In embodiments, the call number may be pre-configured to correspond to the initiator.

The system, device, apparatus, module or unit illustrated in the above embodiments may be implemented by a computer chip or an entity, or by a product having a certain function. One implementation device may be a computer, and the specific form of the computer may be a personal computer, a laptop computer, a cellular phone, a camera phone, a smart phone, a personal digital assistant, a media player, a navigation device, an email transceiver, and a game control, a combination of a tablet, a tablet, a wearable device, or any of these devices.

In an implementation, a computer may include one or more processors (CPUs), input/output interfaces, network interfaces, and memory.

The memory may include non-persistent memory, random access memory (RAM), and/or non-volatile memory in a computer readable medium such as read only memory (ROM) or flash memory. Memory is an example of a computer readable medium.

Computer readable media may include both permanent and non-persistent, removable and non-removable media. Information storage can be implemented by any method or technology. The information can be computer readable instructions, data structures, modules of programs, or other data. Examples of computer storage media may include, but are not limited to, phase change memory (PRAM), static random-access memory (SRAM), dynamic random-access memory (DRAM), other types of random access memory (RAM), read only memory. (ROM), electrically erasable programmable read only memory (EEPROM), flash memory or other memory technology, compact disk read only memory (CD-ROM), digital versatile disk (DVD) or other optical storage, magnetic tape cartridges, magnetic tape storage or other magnetic storage devices or any other non-transportable media can be used to store information that can be accessed by a computing device. As defined herein, computer readable media does not include temporary storage computer readable media, such as modulated data signals and carrier waves.

It is also to be understood that the terms “comprise” or “comprises” or “comprising” or any other variations are intended to encompass a non-exclusive inclusion, such that a process, method, article, other elements not explicitly listed, or elements that are inherent to such a process, method, commodity, or equipment. An element defined by the phrase “comprising a . . . ” does not exclude the presence of additional equivalent elements in the process, method, item, or device including the element.

Exemplary embodiments will be described in detail herein, examples of which are illustrated in the accompanying drawings. The following description refers to the same or similar elements in the different figures unless otherwise indicated. The embodiments described in the following exemplary embodiments do not represent all embodiments consistent with the present disclosure. Instead, they are merely examples of devices and methods consistent with aspects of the present disclosure as detailed in the appended claims.

The terminology used in the present disclosure is for the purpose of describing particular embodiments and is not intended to be limiting. The singular forms “a”, “the” and “the” It should also be understood that the term “and/or” as used herein refers to and encompasses any and all possible combinations of one or more of the associated listed items.

It should be understood that although the terms first, second, third, etc. may be used to describe various information in this application, such information should not be limited to these terms. These terms are only used to distinguish the same type of information from each other. For example, the first information may also be referred to as the second information without departing from the scope of the present disclosure. Similarly, the second information may also be referred to as the first information. Depending on the context, the word “if” as used herein may be interpreted as “when” or “when” or “in response to a determination.”

The above is only the preferred embodiment of the present disclosure and is not intended to limit the present disclosure. Any modifications, equivalent substitutions, improvements, etc., which are made within the spirit and principles of the present disclosure, should be included in the present disclosure. Within the scope of protection.

### Example Clauses

A. A method comprising: receiving, at a server, a call request from an initiator; and sending, by the server, a push message to a target object, wherein the push message includes a call number associated with the initiator and a call number description, causing the target object to display the call number description on an incoming call interface upon receiving the call request.

B. The method as recited in paragraph A, further comprising: determining, by the server, whether the call number associated with the initiator and the call number description is stored in the target object; and in response to a determination that the call number associated with the initiator and the call number description is not stored in the target object, sending the push message including the call number and the call number description to the target object, wherein the determining whether the call number associated with the initiator and the call number description is stored in the target object comprises determining whether the call number and the call number description stored in the target object are up-to-date.

C. The method as recited in paragraph B, wherein the determining, by the server, whether the call number associated with the first object and the call number description is stored in the target object further comprises: querying historical data stored at the server to determine whether the target object stores the call number and the call number description; or querying the target object causing the target object to determine whether the call number and the call number description are stored therein.

D. The method as recited in paragraph C, wherein the querying historical data stored at the server to determine whether the target object stores the call number and the call number description further comprises: determining whether the historical data includes a historical push message sent by the server to the target object, wherein the historical push message includes at least one of the call number or the call number description.

E. The method as recited in paragraph A, wherein the sending, by the server, a push message to a target object further comprises: if the call number description is stored in the server, generating the push message using the stored description and sending the push message to the target object; and if the call number description is not stored in the server, generating the push message using the call number description associated with the call request and sending the push message to the target object.

F. The method as recited in paragraph A, wherein when the call number is the personal number of the initiator, the call number description is personal description information of the initiator; when the call number is a public number of an organization to which the initiator belongs, the call number description is organization description information of the organization to which the initiator belongs.

G. The method as recited in paragraph A, further comprising: sending, by the server, the push message to an operating system server corresponding to an operating system of the target object, causing the operating system server to send the push message to the target object, wherein the operating system of the target object sets a permission restriction on an installed third-party application, so that the third-party application cannot identify the caller number of the call request received by the target object and display an identified result on the incoming call interface.

H. The method as recited in paragraph G, wherein: the push message further instructs the target object to save the call number and the call number description to a call number identification information database of the target object, causing the target object to obtain the call number description upon receiving the call request based on the call number, and display the call number description on the incoming call interface of the second terminal, wherein the call number identification information database is provided by the operating system of the target object.

I. The method as recited in paragraph A, further comprising: receiving, at the server, a storage success message returned by the target object, indicating that the target object has stored the call number and the description corresponding to the caller number to a call number identification information database; and performing, through a communication network, a call operation respectively on the first object who initiated the call request and the target object based on the call number.

J. An apparatus comprising: one or more processors; memory; a first call request receiving module stored in the memory and executable by the one or more processors to cause a server to receive a call request from an initiator; and a first message sending module stored in the memory and executable by the one or more processors to cause the server to send a push message to a target object, wherein the push message includes a call number associated with the initiator and a call number description, causing the target object to display the call number description on an incoming call interface upon receiving the call request.

K. The apparatus as recited in paragraph J, further comprising: a storage determining module stored in the memory and executable by the one or more processors to cause the server to determine whether the call number associated with the initiator and the call number description is stored in the target object; and in response to a determination that the call number associated with the initiator and the call number description is not stored in the target object, cause the server to include the call number and the call number description in the push message sent to the target object, wherein the storage determining module further causes the server to determine whether the call number and the call number description stored in the target object are up-to-date.

L. The apparatus as recited in paragraph K, wherein to determine whether the call number associated with the initiator and the call number description is stored in the target object, the first message sending module further causes the server to query historical data stored at the server to determine whether the target object stores the call number and the call number description; or query the target object causing the target object to determine whether the call number and the call number description are stored therein.

M. The apparatus as recited in paragraph L, wherein to query historical data stored at the server to determine whether the target object stores the call number and the call number description, the first message sending module further causes the server to determine whether the historical data includes a historical push message sent by the server to the target object, wherein the historical push message includes at least one of the call number or the call number description.

N. The apparatus as recited in paragraph J, wherein the first message sending module further causes the server to if the call number description is stored in the server, generate the push message using the stored description and sending the push message to the target object; and if the call number description is not stored in the server, generate the push message using the call number description associated with the call request and sending the push message to the target object.

O. The apparatus as recited in paragraph J, wherein: when the call number is the personal number of the initiator, the call number description is personal description information of the initiator; when the call number is a public number of an organization to which the initiator belongs, the call number description is organization description information of the organization to which the initiator belongs.

P. The apparatus as recited in paragraph J, wherein the first message sending module further causes the server to send the push message to an operating system server corresponding to an operating system of the target object, causing the operating system server to send the push message to the target object, the operating system of the target object sets a permission restriction on an installed third-party application, so that the third-party application cannot identify the caller number of the call request received by the target object and display an identified result on the incoming call interface.

Q. The apparatus as recited in paragraph P, wherein: the push message further instructs the target object to save the call number and the call number description to a call number identification information database of the target object, causing the target object to obtain the call number description upon receiving the call request based on the call number, and display the call number description on the incoming call interface of the second terminal, wherein the call number identification information database is provided by the operating system of the target object.

R. The apparatus as recited in paragraph J, further comprising: a message receiving module stored in the memory and executable by the one or more processors to cause the server to receive a storage success message returned by the target object, indicating that the target object has stored the call number and the description corresponding to the caller number to a call number identification information database; and a call module stored in the memory and executable by the one or more processors to cause the server to perform, through a communication network, a call operation respectively on the first object who initiated the call request and the target object based on the call number.

S. A computer-readable storage medium storing computer-readable instructions that, when executed by the one or more processors, cause the one or more processors to perform operations comprising: receiving, at a server, a call request from an initiator; and sending, by the server, a push message to a target object, wherein the push message includes a call number associated with the initiator and a call number description, causing the target object to display the call number description on an incoming call interface upon receiving the call request.

T. The computer-readable storage as recited in paragraph S, wherein the computer-readable instructions, when executed by the one or more processors, cause the one or more processors to perform further operations comprising: determining, by the server, whether the call number associated with the initiator and the call number description is stored in the target object; and in response to a determination that the call number associated with the initiator and the call number description is not stored in the target object, sending the push message including the call number and the call number description to the target object, wherein the determining whether the call number associated with the initiator and the call number description is stored in the target object comprises determining whether the call number and the call number description stored in the target object are up-to-date.

U. The computer-readable storage as recited in paragraph S, wherein the determining, by the server, whether the call number associated with the first object and the call number description is stored in the target object further comprises: querying historical data stored at the server to determine whether the target object stores the call number and the call number description; or querying the target object causing the target object to determine whether the call number and the call number description are stored therein.

V. The computer-readable storage as recited in paragraph U, wherein the querying historical data stored at the server to determine whether the target object stores the call number and the call number description further comprises: determining whether the historical data includes a historical push message sent by the server to the target object, wherein the historical push message includes at least one of the call number or the call number description.

W. The computer-readable storage as recited in paragraph S, wherein the sending, by the server, a push message to a target object further comprises: if the call number description is stored in the server, generating the push message using the stored description and sending the push message to the target object; and if the call number description is not stored in the server, generating the push message using the call number description associated with the call request and sending the push message to the target object.

X. The computer-readable storage as recited in paragraph S, wherein: when the call number is the personal number of the initiator, the call number description is personal description information of the initiator; when the call number is a public number of an organization to which the initiator belongs, the call number description is organization description information of the organization to which the initiator belongs.

Y. The computer-readable storage as recited in paragraph S, further comprising: sending, by the server, the push message to an operating system server corresponding to an operating system of the target object, causing the operating system server to send the push message to the target object, wherein the operating system of the target object sets a permission restriction on an installed third-party application, so that the third-party application cannot identify the caller number of the call request received by the target object and display an identified result on the incoming call interface.

Z. The computer-readable storage as recited in paragraph Y, wherein: the push message further instructs the target object to save the call number and the call number description to a call number identification information database of the target object, causing the target object to obtain the call number description upon receiving the call request based on the call number, and display the call number description on the incoming call interface of the second terminal, wherein the call number identification information database is provided by the operating system of the target object.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, at a server, a call request from an initiator; and
sending, by the server, a push message to a target object, wherein the push message includes a call number associated with the initiator and a call number description, causing the target object to display the call number description on an incoming call interface upon receiving the call request.

2. The method according to claim 1, further comprising:
determining, by the server, whether the call number associated with the initiator and the call number description is stored in the target object; and
in response to a determination that the call number associated with the initiator and the call number description is not stored in the target object, sending the push message including the call number and the call number description to the target object,
wherein
the determining whether the call number associated with the initiator and the call number description is stored in the target object comprises determining whether the call number and the call number description stored in the target object are up-to-date.

3. The method according to claim 2, wherein the determining, by the server, whether the call number associated with the first object and the call number description is stored in the target object further comprises:
querying historical data stored at the server to determine whether the target object stores the call number and the call number description; or
querying the target object causing the target object to determine whether the call number and the call number description are stored therein.

4. The method according to claim 3, wherein the querying historical data stored at the server to determine whether the target object stores the call number and the call number description further comprises:
determining whether the historical data includes a historical push message sent by the server to the target object,
wherein the historical push message includes at least one of the call number or the call number description.

5. The method of claim 1, wherein the sending, by the server, a push message to a target object further comprises:
if the call number description is stored in the server, generating the push message using the stored description and sending the push message to the target object; and
if the call number description is not stored in the server, generating the push message using the call number description associated with the call request and sending the push message to the target object.

6. The method of claim 1, wherein:
when the call number is the personal number of the initiator, the call number description is personal description information of the initiator;
when the call number is a public number of an organization to which the initiator belongs, the call number description is organization description information of the organization to which the initiator belongs.

7. The method of claim 1, further comprising:
sending, by the server, the push message to an operating system server corresponding to an operating system of the target object, causing the operating system server to send the push message to the target object,
wherein
the operating system of the target object sets a permission restriction on an installed third-party application, so that the third-party application cannot identify the caller number of the call request received by the target object and display an identified result on the incoming call interface.

8. The method of claim 7, wherein:
the push message further instructs the target object to save the call number and the call number description to a call number identification information database of the target object, causing the target object to obtain the call number description upon receiving the call request based on the call number, and display the call number description on the incoming call interface of the second terminal,
wherein
the call number identification information database is provided by the operating system of the target object.

9. The method of claim 1, further comprising:
receiving, at the server, a storage success message returned by the target object, indicating that the target object has stored the call number and the description corresponding to the caller number to a call number identification information database; and
performing, through a communication network, a call operation respectively on the first object who initiated the call request and the target object based on the call number.

10. An apparatus comprising:
one or more processors;
memory;
a first call request receiving module stored in the memory and executable by the one or more processors to cause a server to receive a call request from an initiator; and
a first message sending module stored in the memory and executable by the one or more processors to cause the server to send a push message to a target object, wherein the push message includes a call number associated with the initiator and a call number description, causing the target object to display the call number description on an incoming call interface upon receiving the call request.

11. The apparatus of claim 10, further comprising:
a storage determining module stored in the memory and executable by the one or more processors to
cause the server to determine whether the call number associated with the initiator and the call number description is stored in the target object; and
in response to a determination that the call number associated with the initiator and the call number description is not stored in the target object, cause the server to include the call number and the call number description in the push message sent to the target object,
wherein
the storage determining module further causes the server to determine whether the call number and the call number description stored in the target object are up-to-date.

12. The apparatus of claim 11, wherein to determine whether the call number associated with the initiator and the call number description is stored in the target object, the first message sending module further causes the server to
query historical data stored at the server to determine whether the target object stores the call number and the call number description; or
query the target object causing the target object to determine whether the call number and the call number description are stored therein.

13. The apparatus of claim 12, wherein to query historical data stored at the server to determine whether the target object stores the call number and the call number description, the first message sending module further causes the server to
determine whether the historical data includes a historical push message sent by the server to the target object,
wherein the historical push message includes at least one of the call number or the call number description.

14. The apparatus of claim 10, wherein the first message sending module further causes the server to
if the call number description is stored in the server, generate the push message using the stored description and sending the push message to the target object; and
if the call number description is not stored in the server, generate the push message using the call number description associated with the call request and sending the push message to the target object.

15. The apparatus of claim 10, wherein:
when the call number is the personal number of the initiator, the call number description is personal description information of the initiator;
when the call number is a public number of an organization to which the initiator belongs, the call number description is organization description information of the organization to which the initiator belongs.

16. The apparatus of claim 10, wherein the first message sending module further causes the server to
send the push message to an operating system server corresponding to an operating system of the target object, causing the operating system server to send the push message to the target object,
wherein
the operating system of the target object sets a permission restriction on an installed third-party application, so that the third-party application cannot identify the caller number of the call request received by the target object and display an identified result on the incoming call interface.

17. The apparatus of claim 16, wherein:
the push message further instructs the target object to save the call number and the call number description to a call number identification information database of the target object, causing the target object to obtain the call number description upon receiving the call request based on the call number, and display the call number description on the incoming call interface of the second terminal,
wherein
the call number identification information database is provided by the operating system of the target object.

18. The apparatus of claim 10, further comprising:
a message receiving module stored in the memory and executable by the one or more processors to cause the server to receive a storage success message returned by the target object, indicating that the target object has stored the call number and the description corresponding to the caller number to a call number identification information database; and
a call module stored in the memory and executable by the one or more processors to cause the server to perform, through a communication network, a call operation respectively on the first object who initiated the call request and the target object based on the call number.

19. A computer-readable storage medium storing computer-readable instructions that, when executed by the one or more processors, cause the one or more processors to perform operations comprising:
receiving, at a server, a call request from an initiator; and
sending, by the server, a push message to a target object, wherein the push message includes a call number associated with the initiator and a call number description, causing the target object to display the call number description on an incoming call interface upon receiving the call request.

20. The computer-readable storage medium of claim 19, wherein the computer-readable instructions, when executed by the one or more processors, cause the one or more processors to perform further operations comprising:
determining, by the server, whether the call number associated with the initiator and the call number description is stored in the target object; and
in response to a determination that the call number associated with the initiator and the call number description is not stored in the target object, sending the push message including the call number and the call number description to the target object,
wherein
the determining whether the call number associated with the initiator and the call number description is stored in the target object comprises determining whether the call number and the call number description stored in the target object are up-to-date.
